(19) United States
(12) Patent Application Publication
(10) Pub. No.: US 2010/0104178 A1
(43) Pub. Date: Apr. 29, 2010

(54) Methods and Systems for Demosaicing

(76) Inventors: Daniel Tamburrino, Nyon (CH); Jon M. Speigle, Vancouver, WA (US); Douglas J. Tweet, Camas, WA (US)

Correspondence Address: Kristine Elizabeth Matthews, 19302 SE 31st Drive, Camas, WA, 98607, US

(21) Appl. No.: 12/256,673

(22) Filed: Oct. 23, 2008

(51) Int. Cl. G06K 9/00; G06K 9/40

(52) U.S. Cl. 382/167; 382/262

(57) ABSTRACT

Aspects of the present invention are related to systems and methods for image demosaicing.

### FIELD OF THE INVENTION

Embodiments of the present invention relate generally to the field of image processing, and more specifically to frequency-domain-based methods and systems for demosaicing.

### BACKGROUND

Typically, a full-color image consists of three color components per pixel. To capture three color components at each pixel, some image-acquisition systems may comprise three separate sensor arrays, each with a different spectral sensitivity, and a method for splitting and projecting the light entering the acquisition system onto each spectral sensor. Other full-color image-acquisition systems may comprise a stacked-photodiode-based sensor at each pixel, wherein three color components at a pixel may be separated by the wavelength-dependent penetration depth of the incident light within the stacked-sensor pixel. Alternatives to full-color image acquisition may comprise less-than-full-color data acquisition at each pixel and full-color reconstruction using interpolation referred to as demosaicing.

### SUMMARY

Some embodiments of the present invention may comprise methods and systems for frequency-domain-based image demosaicing of mixed-pixel-type data.

In some of these embodiments, an intensive signal may be extracted from each un-stacked image in a plurality of un-stacked images associated with the mixed-pixel-type data. Chrominance signals may be determined using the un-stacked data and the extracted intensive signals. The chrominance signals may be de-multiplexed according to color components, and interpolation may be performed on the de-multiplexed chrominance signals to determine missing chrominance data. Full-color image reconstruction may be based on the interpolated chrominance signals and the extracted intensive signals.

In alternative of these embodiments, an intensive signal may be estimated directly from the mixed-pixel-type data. Chrominance signals may be determined using the estimated intensive signal and un-stacked data associated with the mixed-pixel-type data. The chrominance signals may be de-multiplexed according to color components, and interpolation may be performed on the de-multiplexed chrominance signals to determine missing chrominance data. Full-color image reconstruction may be based on the interpolated chrominance signals and the estimated intensive signal.

In alternative embodiments, a chrominance signal may be extracted from each un-stacked image in a plurality of un-stacked images associated with the mixed-pixel-type data. Intensive signals may be determined using the un-stacked data and the extracted chrominance signals. The extracted chrominance signals may be de-multiplexed according to color components, and interpolation may be performed on the de-multiplexed chrominance signals to determine missing chrominance data. Full-color image reconstruction may be based on the interpolated chrominance signals and the intensive signals.

In still alternative embodiments, a chrominance signal may be estimated directly from the mixed-pixel-type data. Intensive signals may be determined using the estimated chrominance signal and un-stacked data associated with the mixed-pixel-type data. The chrominance signal may be de-multiplexed according to color components and interpolation may be performed on the de-multiplexed chrominance signals to determine missing chrominance data. Full-color image reconstruction may be based on the interpolated chrominance signals and the intensive signals.

Some embodiments of the present invention comprise methods and systems for frequency-domain-based image demosaicing of stacked-pixel-type data.

In some of these embodiments, an intensive signal may be extracted from each un-stacked image in a plurality of un-stacked images associated with the stacked-pixel-type data. Chrominance signals may be determined using the un-stacked data and the extracted intensive signals. The chrominance signals may be de-multiplexed according to color components, and interpolation may be performed on the de-multiplexed chrominance signals to determine missing chrominance data. Full-color image reconstruction may be based on the interpolated chrominance signals and the extracted intensive signals.

In alternatives of these embodiments, an intensive signal may be estimated directly from the stacked-pixel-type data. Chrominance signals may be determined using the estimated intensive signal and un-stacked data associated with the stacked-pixel-type data. The chrominance signals may be de-multiplexed according to color components, and interpolation may be performed on the de-multiplexed chrominance signals to determine missing chrominance data. Full-color image reconstruction may be based on the interpolated chrominance signals and the estimated intensive signal.

In alternative embodiments, a chrominance signal may be extracted from each un-stacked image in a plurality of un-stacked images associated with the stacked-pixel-type data. Intensive signals may be determined using the un-stacked data and the extracted chrominance signals. The chrominance signals may be de-multiplexed according to color components and interpolation may be performed on the de-multiplexed chrominance signals to determine missing chrominance data. Full-color image reconstruction may be based on the interpolated chrominance signals and the intensive signals.

In still alternative embodiments, a chrominance signal may be estimated directly from the stacked-pixel-type data. Intensive signals may be determined using the estimated chrominance signal and un-stacked data associated with the stacked-pixel-type data. The chrominance signal may be de-multiplexed according to color components and interpolation may be performed on the de-multiplexed chrominance signals to determine missing chrominance data. Full-color image reconstruction may be based on the interpolated chrominance signals and the intensive signals.

Some embodiments of the present invention may comprise median filtering after full-color image reconstruction.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1A is a picture illustrating a Bayer CFA (prior art);

FIG. 1B is a picture illustrating a composite-filter CMYG CFA (prior art);

FIG. 2A is a picture illustrating an exemplary mixed-pixel-type arrangement;

FIG. 2B is a picture illustrating an exemplary mixed-pixel-type CFA;

FIG. 3 is a picture illustrating an exemplary Fourier representation of a Bayer CFA (prior art);

FIG. 4 is a picture illustrating an exemplary Fourier representation of a 2PFC CFA;

FIG. 5 is a chart showing exemplary embodiments of the present invention comprising full-color image reconstruction from mixed-pixel-type data, wherein intensive information may be extracted from un-stacked image data;

FIG. 6 is a picture illustrating un-stacked images formed from mixed-pixel-type data according to exemplary embodiments of the present invention;

FIG. 7 is a picture showing the frequency response of an exemplary intensive-extraction filter;

FIG. 8 is a chart showing exemplary embodiments of the present invention comprising full-color image reconstruction from mixed-pixel-type data, wherein chrominance information may be extracted from un-stacked image data;

FIG. 9 is a chart showing exemplary embodiments of the present invention comprising full-color image reconstruction from mixed-pixel-type data and median filtering, wherein intensive information may be extracted from un-stacked image data;

FIG. 10 is a chart showing exemplary embodiments of the present invention comprising full-color image reconstruction from mixed-pixel-type data and median filtering, wherein chrominance information may be extracted from un-stacked image data;

FIG. 11 is a chart showing exemplary embodiments of the present invention comprising full-color image reconstruction from mixed-pixel-type data, wherein intensive may be estimated directly from the mixed-pixel-type data;

FIG. 12 is a chart showing exemplary embodiments of the present invention comprising full-color image reconstruction from mixed-pixel-type data and median filtering, wherein intensive may be estimated directly from the mixed-pixel-type data

FIG. 13 is a chart showing exemplary embodiments of the present invention comprising full-color image reconstruction from mixed-pixel-type data, wherein chrominance may be estimated directly from the mixed-pixel-type data;

FIG. 14 is a chart showing exemplary embodiments of the present invention comprising full-color image reconstruction from mixed-pixel-type data and median filtering, wherein chrominance may be estimated directly from the mixed-pixel-type data;

FIG. 15 is a chart showing exemplary embodiments of the present invention comprising full-color image reconstruction from stacked-pixel-type data, wherein intensive information may be extracted from un-stacked image data;

FIG. 16 is a chart showing exemplary embodiments of the present invention comprising full-color image reconstruction from stacked-pixel-type data, wherein chrominance information may be extracted from un-stacked image data;

FIG. 17 is a chart showing exemplary embodiments of the present invention comprising full-color image reconstruction from stacked-pixel-type data and median filtering, wherein intensive information may be extracted from un-stacked image data;

FIG. 18 is a chart showing exemplary embodiments of the present invention comprising full-color image reconstruction from stacked-pixel-type data and median filtering, wherein chrominance information may be extracted from un-stacked image data; and

FIG. 19 is a chart showing exemplary embodiments of the present invention comprising full-color image reconstruction from stacked-pixel-type data, wherein an intensive signal may be estimated directly from the stacked-pixel-type data;

FIG. 20 is a chart showing exemplary embodiments of the present invention comprising full-color image reconstruction from stacked-pixel-type data, wherein a chrominance signal may be estimated directly from the stacked-pixel-type data;

FIG. 21 is a chart showing exemplary embodiments of the present invention comprising full-color image reconstruction from stacked-pixel-type data and median filtering, wherein an intensive signal may be estimated directly from the stacked-pixel-type data; and

FIG. 22 is a chart showing exemplary embodiments of the present invention comprising full-color image reconstruction from stacked-pixel-type data and median filtering, wherein a chrominance signal may be estimated directly from the stacked-pixel-type data.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention, but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Typically, a full-color image consists of three color components per pixel. To capture three color components at each pixel, some image-acquisition systems may comprise three separate sensor arrays, each with a different spectral sensitivity, and a method for splitting and projecting the light entering the acquisition system onto each spectral sensor. Other full-color image-acquisition systems may comprise a stacked-photodiode-based sensor, wherein three color components at a pixel may be separated by the wavelength-dependent penetration depth of the incident light within the stacked-sensor pixel.

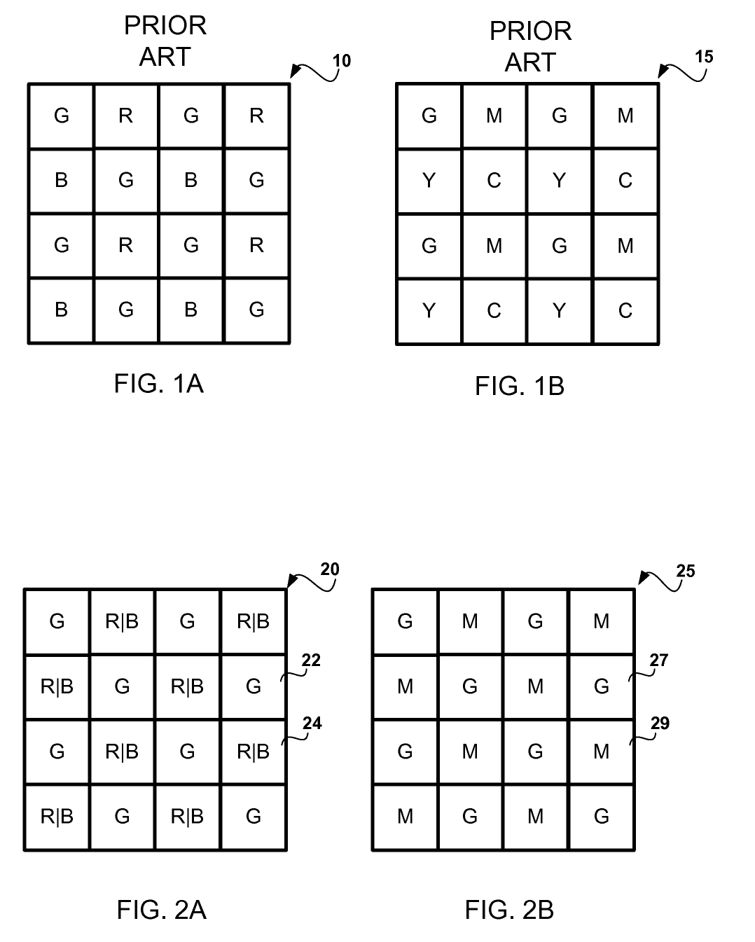

Alternatives to full-color image acquisition may comprise less-than-full-color data acquisition at each pixel and full-color reconstruction using interpolation. A standard image-acquisition system may comprise a 2-dimensional (2D) sensor array and a color filter array (CFA). The colors of a scene may be captured using the single sensor array, wherein a particular color channel may be detected at each pixel in accordance with the CFA. FIG. 1A shows the well-known Bayer CFA 10 consisting of a tiling using a 2×2 cell of two green (G) filters, one red (R) filter and one blue (B) filter on a rectangular grid. Alternative color filter arrays may comprise different spatial arrangement, filter absorption spectra, number of filters or pixel shape. FIG. 1B depicts one alternative CFA, a composite-filter CMYG (cyan-magenta-yellow-green) CFA 15. Each site in these CFAs corresponds to a single photo-sensor.

Color components which are not measured at a pixel may be interpolated using a technique which may be referred to as demosaicing (also, demosaicking). Demosaicing methods may be specific to CFA properties, which may include spatial arrangement, filter absorption spectra, number of filters, pixel shape and other CFA properties. Some demosaicing techniques may introduce artifacts and may be computationally expensive.

Alternative image-acquisition systems, wherein less-than-full-color data is captured at each pixel, may comprise sensors whereby multiple color components may be measured at some pixels and single color components may be measured at other pixels. An image-acquisition system as such may be referred to as a mixed-pixel-type image-acquisition system. Some of these image-acquisition systems may comprise stacked-photodiode-based sensors at some pixels, thereby acquiring multiple color components at these pixels, and single a photo-sensor covered by a particular color filter at other pixels, thereby acquiring a single color component at these other pixels.

An exemplary arrangement 20 of this type is depicted in FIG. 2A. Pixels labeled “G” (for example 22) may correspond to a standard pixel covered with a green filter. Pixels labeled “R|B” (for example 24) may correspond to a pixel covered with a magenta filter which passes the longer-wavelength (reddish) and shorter-wavelength (bluish) light which may be separated by the wavelength-dependent penetration depth with in these stacked-sensor pixels.

This arrangement may be denoted [G, R|B]. In this arrangement, full-color information is sensed at each two, horizontally or vertically neighboring, pixels: a standard pixel covered with a green filter, whereby green spectral content may be sensed; and a stacked-sensor pixel covered with a magenta filter, whereby red spectral content and blue spectral content may be sensed. FIG. 2B depicts the two-filter CFA 25 comprising standard pixels (for example 27) with a green filter and stacked two-color pixels covered with a magenta filter (for example 29). Image data acquired from the above-described sensor arrangement may be denoted f_{[G,R|B]} indicating a standard green pixel and a stacked red/blue pixel. Alternative arrangements may include [R, B|G], [B, R|G], [G, G|R|B], [G, G, G, R|B], [G, R|B, R|B, G] and other arrangements comprising two different pixel types.

A sensor, wherein full color is detected with two pixels, may be referred to as a “2 Pixels Full Color” (“2PFC”) sensor and the CFA may be composed of two different types of pixels and may use only two color filters. With 2PFC, and other mixed-pixel-type sensors, typically required digital processing steps may be similar to those used with a standard sensor. Exemplary digital processing which may be similar includes white balancing, tone mapping and color correction. However, standard-sensor demosaicing may not apply to mixed-pixel-type sensor. Methods and systems for demosaicing mixed-pixel-type data may be desirable.

Other alternative image-acquisition systems, wherein less-than-full-color data is captured at each pixel, may comprise sensor arrangements whereby multiple color components may be obtained at each pixel. An image-acquisition system as such may be referred to as a stacked-pixel-type image-acquisition system. Some of these image-acquisition systems may comprise tilings of stacked sensors, for example [G|R, G|B], [B|R, B|G] and other stacked-sensor tilings. Other of these image-acquisition systems may comprise two separate sensor arrays and a method for splitting and projecting the light entering the acquisition system onto each spectral sensor, whereby one of the sensor arrays may sense one color component (for example, green), and the other sensor array may be overlaid with a CFA comprising alternating filters associated with the remaining color components (for example, red and green filters). Still other of these image-acquisition systems may comprise a single sensor array used in conjunction with optical elements that allow sensing of multiple wavelength bands at each photosite. An exemplary design of this type is disclosed in U.S. Pat. No. 7,138,663, entitled “Color separation device of solid-state image sensor.” As for mixed-pixel-type image-acquisition systems, standard-sensor demosaicing may not apply to stacked-pixel-type image-acquisition systems. Methods and systems for demosaicing mixed-pixel-type data and stacked-pixel-type data may be desirable. These may be referred to as methods and systems for demosaicing non-standard data.

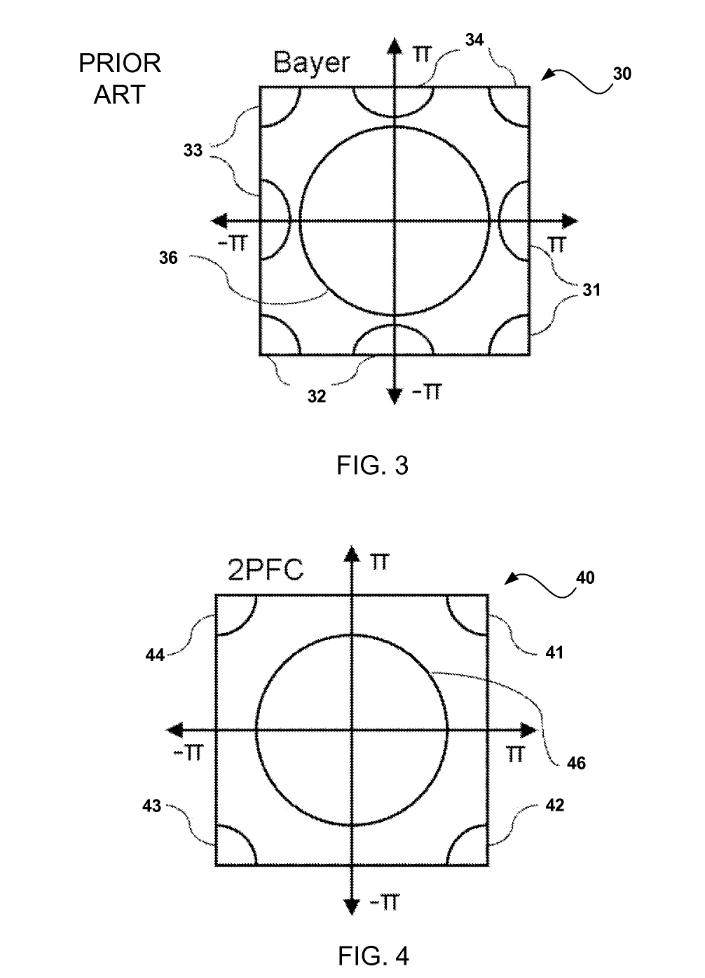

Generally, demosaicing algorithms may be separated into two classes: spatial-domain approaches and frequency-domain approaches. The frequency-domain approaches for standard sensors and the Bayer CFA may exploit the fact that the intensive information and the chrominance information of a Bayer CFA image are separated in a frequency-domain representation. FIG. 3 illustrates an approximation of the average frequency response 30 of a Bayer CFA. For a Bayer CFA image, the intensive information 36 is located at lower spatial frequencies (central portion of the Fourier representation), whereas the chrominance information 31-34 is located at higher frequencies (borders and corners of the Fourier representation). Due to non-negligible cross-talk between the intensive information and chrominance information, frequency-domain demosaicing methods designed for the Bayer CFA may produce images with color aliasing and other undesirable artifacts.

However, for a 2PFC CFA, greater separation of the intensive information and the chrominance information may be obtained, with chrominance information being located primarily at the corners of the Fourier representation. FIG. 4 illustrates an approximation of the average frequency response 40 of the exemplary 2PFC CFA 25 shown in FIG. 2B. The intensive information 46 in the central portion of the Fourier representation 40 is well separated from the chrominance information 41-44 in the corners of the Fourier representation 40. Frequency-domain demosaicing methods for non-Bayer CFAs may be desirable. In particular, frequency-domain demosaicing methods for mixed-pixel-type and stacked-pixel-type CFAs may be desirable.

The diagrams shown in FIG. 3 and FIG. 4 approximate the average frequency response for the given CFAs and may be computed by applying the CFA to a set of test images and computing the frequency response.

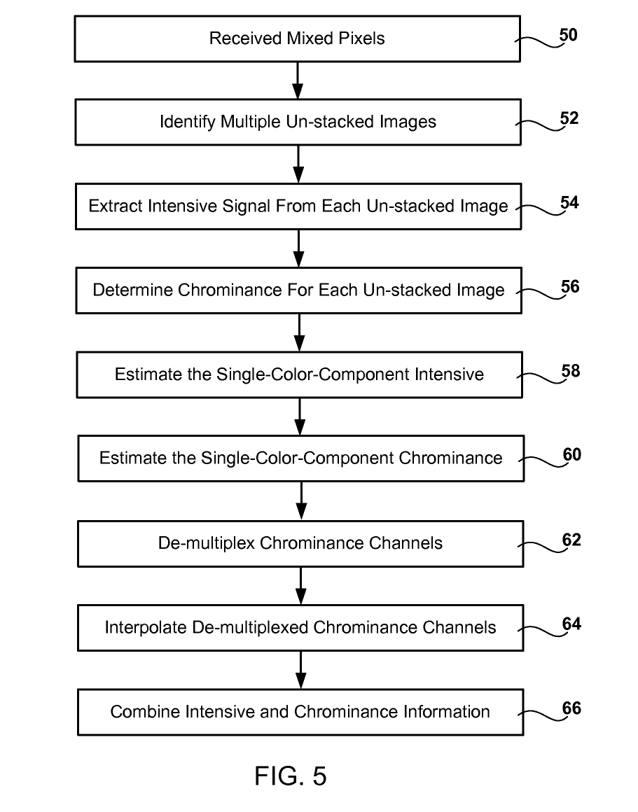

Embodiments of the present invention comprise methods and systems for frequency-domain-based demosaicing of mixed-pixel-type data and stacked-pixel-type data. Some of these embodiments may be described in relation to FIG. 5. In these embodiments of the present invention, mixed-pixel-type data may be received 50. Mixed-pixel-type data may comprise single-color-component pixels for which the value of a single color-component may be known and multiple-color-component pixels for which multiple color values corresponding to more than one color-component may be known.

Multiple un-stacked images may be identified 52 from the mixed pixels. In some embodiments of the present invention, each un-stacked image may be associated with a separate buffer, or other memory, and identification 52 of the multiple un-stacked images may comprise separation of the mixed pixels into images with single-valued pixels. In alternative embodiments of the present invention, sensed, mixed-pixel-type data may be stored in a single buffer, or other memory, and an un-stacked image may be processed by indexing the single, sensed-data buffer. In these embodiments, identification 52 of the multiple un-stacked images may comprise the indexing function. In still alternative embodiments of the present invention, sensed, mixed-pixel-type data may be stored in a single buffer, or other memory, and a masking function may separate the single-valued pixels associated with un-stacked pixels during the demosaicing, thereby identifying 52 the un-stacked images. Identification 52 of multiple un-stacked images is intended to reflect the decomposition of mixed-pixel-type and stacked-pixel-type data into single-valued pixel data for demosaicing. In some embodiments of the present invention, identification 52 of multiple un-stacked images may be implicit in the processing of the sensed, mixed-pixel-type data.

Each un-stacked image may comprise the single-color-component pixel data and the values associated with one of the color-components of the multiple-color-component pixels. An intensive signal associated with each un-stacked image may be extracted 54. In some embodiments of the present invention, the intensive signals may be extracted 54 by applying an intensive-extraction filter to each of the un-stacked images. In some of these embodiments, the same intensive-extraction filter may be used for each un-stacked image. In alternative of these embodiments, the intensive-extraction filter may be specific to the color-component combination of each un-stacked image.

After the intensive signal is extracted 54 from each un-stacked image, a chrominance signal may be determined 56 for each un-stacked image. In some embodiments, the chrominance signal associated with an un-stacked image may be determined 56 according to:

f_{C}^{unstacked}=f_{[ ]}^{unstacked}−f_{I}^{unstacked},

where f_{[ ]}^{unstacked} denotes an un-stacked image, f_{I}^{unstacked} denotes the extracted intensive signal associated with the un-stacked image and f_{C}^{unstacked} denotes the chrominance signal associated with the un-stacked image. In alternative embodiments, the chrominance signal may be determined 56 according to:

$${f}_{C}^{unstacked} = \frac{{f}_{[ ]}^{unstacked}}{{f}_{I}^{unstacked}} .$$

Because the color information associated with the single-color-component pixels is carried in each un-stacked image, an intensive signal associated with this color channel may be estimated 58 from the intensive information extracted 54 from the un-stacked images. In some embodiments of the present invention, the single-color-component intensive estimate may comprise the average of the intensive signals associated with the un-stacked images. In alternative embodiments, the single-color-component intensive estimate may comprise the weighted average of the intensive signals associated with the un-stacked images. In some of these embodiments, the weights may be associated with the relative correlation of the color-component channels respectively. In some embodiments of the present invention, a color shift may be introduced by the weighted average, and a color-correction may be applied to compensate for the color shift.

Similarly, a chrominance signal associated with the color channel corresponding to the single-color-component pixels may be estimated 60. In some embodiments of the present invention, the single-color-component chrominance estimate may comprise the average of the chrominance signals associated with the un-stacked images. In alternative embodiments, the single-color-component chrominance estimate may comprise the weighted average of the chrominance signals associated with the un-stacked images. In some of these embodiments, the weights may be associated with the relative correlation of the color-component channels respectively. In some embodiments of the present invention, a color shift may be introduced by the weighted average, and a color-correction may be applied to compensate for the color shift.

The chrominance channels may be de-multiplexed 62 according to the CFA associated with the mixed-pixel data, and missing chrominance values may be interpolated 64. Exemplary interpolation methods comprise bilinear interpolation, linear interpolation, spline interpolation, cubic interpolation, cosine interpolation, Hermite interpolation, polynomial interpolation and other interpolation methods known in the art. The interpolated chrominance signals and the extracted intensive information may be combined 66, thereby reconstructing a full-color image.

Some embodiments of the present invention described in relation to FIG. 5 may be illustrated for a pixel arrangement [c1, c2|c3], where c1, c2 and c3 represent three color components, and the received 50 mixed-pixel-type data may be denoted f_{[c1,c2|c3]}.

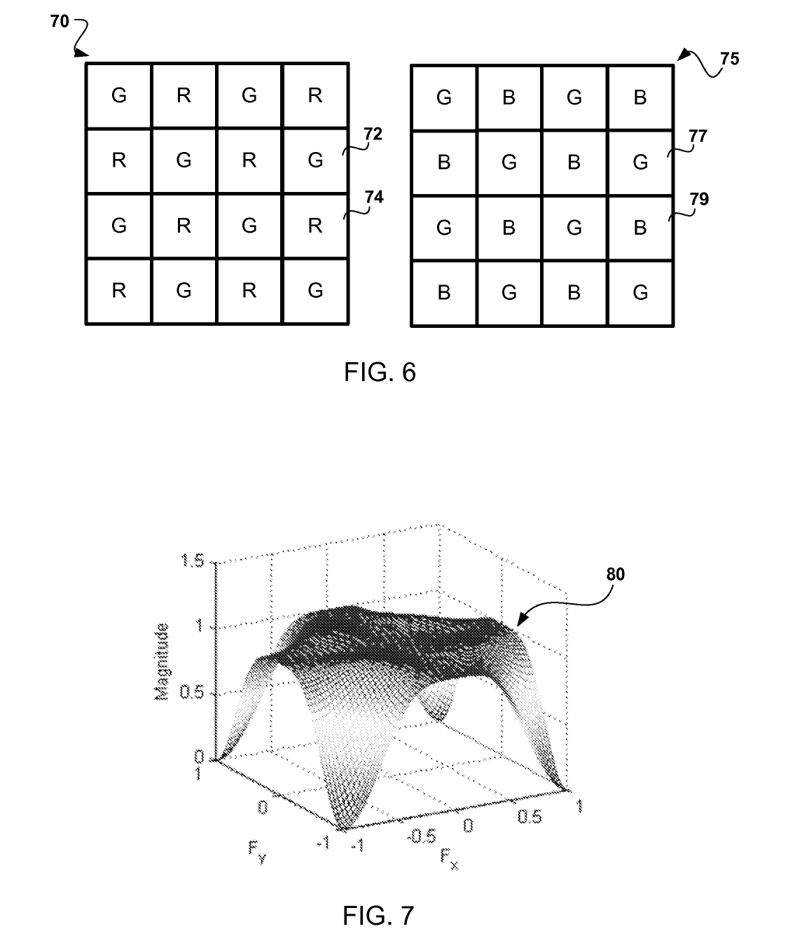

The mixed-pixel data may be un-stacked 52, and the multiple un-stacked images may be denoted f_{[c1,c2|c3]}^{c1c2} and f_{[c1,c2|c3]}^{c1c3}. An un-stacked image may comprise all single-color-component pixels and one of the multiple-color-components of the stacked pixels. For the exemplary 2PFC sensor, [G, R|B], described above, the mixed-pixel data corresponds to the image f_{[G,R|B]}. From the mixed-pixel data, two un-stacked images, which may be described in relation to FIG. 6, may be identified: a first image 70, which may be denoted f_{[G,R|B]}^{GR}, comprising the green (for example 72) and red (for example 74) color-component values; and a second image 75, which may be denoted f_{[G,R|B]}^{GB}, GB comprising the green (for example 77) and blue (for example 79) color-component values. The green values at corresponding locations in the two un-stacked images are the same values (for example, 72 and 79).

An intensive signal associated with each un-stacked image may be extracted 54. For the illustrative pixel arrangement [c1, c2|c3], the intensive associated with the un-stacked images f_{[c1,c2|c3]}^{c1c2} and f_{[c1,c2|c3]}^{c1c3} may be denoted f_{I}^{c1c2} and f_{I}^{c1c3}, respectively. Intensive extraction 54 may comprise convolution with an intensive-extraction kernel according to:

f_{I}^{c1c2}=h_{I}^{c1c2}*f_{[c1,c2|c3]}^{c1c2}

and

f_{I}^{c1c3}=h_{I}^{c1c3}*f_{[c1,c2|c3]}^{c1c3}

where * denotes convolution and h_{I}^{c1c2} and h_{I}^{c1c3} may be the intensive-extraction kernels associated with the color-component combinations c1-c2 and c1-c3, respectively. In some embodiments of the present invention, h_{I}^{c1c2}=h_{I}^{c1c3}=h_{I}.

For the exemplary 2PFC sensor, [G, R|B], two intensive images may be formed according to:

f_{I}^{GR}=h_{I}^{GR}*f_{[G,R|B]}^{GR}

and

f_{I}^{GB}=h_{I}^{GB}*f_{[G,R|B]}^{GB}

where * denotes convolution and h_{I}^{GR} and h_{I}^{GB} may be the intensive-extraction kernels associated with the color-component combinations green-red and green-blue, respectively. In some embodiments of the present invention, h_{I}^{GR}=h_{I}^{GB}=h_{I}. In some of these embodiments, a 5×5 filter may be used to extract intensive information. An exemplary 5×5 filter may be:

$$\frac{1}{64} [ \begin{matrix}0 & 1 & - 2 & 1 & 0 \\ 1 & - 4 & 6 & - 4 & 1 \\ - 2 & 6 & 56 & 6 & - 2 \\ 1 & - 4 & 6 & - 4 & 1 \\ 0 & 1 & - 2 & 1 & 0\end{matrix} ] ,$$

for which the frequency response 80 is illustrated in FIG. 7.

After an intensive signal is extracted 54 from each un-stacked image, a chrominance may be determined 56 for each un-stacked image. In some embodiments, the chrominance may be determined 56 according to:

f_{C}^{c1c2}=f_{[c1,c2|c3]}^{c1c2}−f_{I}^{c1c2}

and

f_{C}^{c1c3}=f_{[c1,c2|c3]}^{c1c3}−f_{I}^{c1c3}

and, in alternative embodiments, the chrominance may be determined 56 according to:

$${f}_{C}^{c 1 c 2} = \frac{{f}_{[ c 1 , c 2 \vert c 3 ]}^{c 1 c 2}}{{f}_{I}^{c 1 c 2}}$$

$$and$$

$${f}_{C}^{c 1 c 3} = \frac{{f}_{[ c 1 , c 2 \vert c 3 ]}^{c 1 c 3}}{{f}_{I}^{c 1 c 3}} .$$

Because the color information associated with the single-color-components pixels is carried in each un-stacked image, an intensive signal associated with this color channel may be estimated 58 from the intensive information extracted 54 from the un-stacked images. In some embodiments of the present invention, the estimate may be determined according to:

$${f}_{I}^{c 1} = \frac{{f}_{I}^{c 1 c 2} + {f}_{I}^{c 1 c 3}}{2} ,$$

and in alternative embodiments, the estimate may be determined according to:

f_{I}^{c1}=α₂f_{I}^{c1c2}+α₃f_{I}^{c1c3},

where α₂ and α₃ are weights, which may, in some embodiments of the present invention, reflect the relative correlation of the c1-c2 components and the c1-c3 color channels, respectively. In alternative embodiments, the estimate may be determined according to:

$${f}_{I}^{c 1} = {\sum }_{( i , j ) ∈ N} {w}_{I} ( i , j ) {f}_{I}^{c 1 c 2} ( i , j ) + {v}_{I} ( i , j ) {f}_{I}^{c 1 c 3} ( i , j ) ,$$

where N is a neighborhood proximate to the location in f_{I}^{c1} for which the estimate is being calculated and w_{I}(i, j) and v_{I}(i, j) may correspond to the weights for the c1-c2 and c1-c3 un-stacked images, respectively.

Similarly, a chrominance signal associated with the color channel corresponding to the single-color-component pixels may be estimated 60. In some embodiments of the present invention, the estimate may be determined according to:

$${f}_{C}^{c 1} = \frac{{f}_{C}^{c 1 c 2} + {f}_{C}^{c 1 c 3}}{2} ,$$

and in alternative embodiments, the estimate may be determined according to:

f_{C}^{c1}=β₂f_{C}^{c1c2}+β₃f_{C}^{c1c3},

where β₂ and β₃ are weights, which may, in some embodiments of the present invention, reflect the relative correlation of the c1-c2 components and the c1-c3 color channels, respectively. In alternative embodiments, the estimate may be determined according to:

$${f}_{C}^{c 1} = {\sum }_{( i , j ) ∈ N} {w}_{C} ( i , j ) {f}_{C}^{c 1 c 2} ( i , j ) + {v}_{C} ( i , j ) {f}_{C}^{c 1 c 3} ( i , j ) ,$$

where N is a neighborhood proximate to the location in f_{C}^{c1} for which the estimate is being calculated and w_{C}(i, j) and v_{C} (i, j) correspond to the weights for the c1-c2 and c1-c3 un-stacked images, respectively.

Letting C={f_{C}^{c1c2}; f_{C}^{c1}; f_{C}^{c1c3}} denote the 3-channel, multiplexed chrominance values, the chrominance channels may be de-multiplexed 62 according to the CFA associated with the mixed-pixel-type data, and missing chrominance values may be interpolated 64. Exemplary interpolation methods comprise bilinear interpolation, linear interpolation, spline interpolation, cubic interpolation, cosine interpolation, Hermite interpolation, polynomial interpolation and other interpolation methods known in the art. The interpolated chrominance channels may be denoted f_{Ĉ}^{c1}, f_{Ĉ}^{c2} and f_{Ĉ}^{c3}. In some embodiments of the present invention wherein the chrominance may be determined 56 by subtraction, the interpolated chrominance signal and the extracted intensive signals may be combined 66 according to:

f_{c1}=f_{I}^{c1}+f_{Ĉ}^{c1},

f_{c2}=f_{I}^{c1c2}+f_{Ĉ}^{c2}

and

f_{c3}=f_{I}^{c1c3}+f_{Ĉ}^{c3},

where f_{c1}, f_{c2} and f_{c3} are reconstructed color-component images. In embodiments wherein the chrominance may be determined 56 by a ratio, interpolated chrominance and extracted intensive information may be combined 66 according to:

f_{c1}=f_{I}^{c1}×f_{Ĉ}^{c1},

f_{c2}=f_{I}^{c1c2}×f_{Ĉ}^{c2}

and

f_{c3}=f_{I}^{c1c3}×f_{Ĉ}^{c3},

where × denotes multiplication.

In some embodiments of the present invention, reconstructed color signals may be converted to an output color space that is distinct from the sensor color space or color space represented by the intensive signals f_{I}^{c1}, f_{I}^{c1c2}, and f_{I}^{c1c3} and interpolated chrominance signals, f_{Ĉ}^{c1}, f_{Ĉ}^{c2} and f_{Ĉ}^{c3}. Conversion may be to any of a number of standardized RGB color spaces including the exemplary color spaces: SMPTE RP 145 RGB, IEC 61966-2-1 sRGB, ITU-R Rec. BT.709 RGB, IEC 61966-2-2 scRGB, and AdobeRGB. Generally, these color spaces may be defined as a transformation relative to the device-independent CIE 1931 XYZ color space. Conversion may also be to arbitrary RGB color spaces that may be similarly defined using International Color Consortium (ICC) color profiles. Conversion may also be to non-RGB color spaces, for example, color spaces representing color using an intensive and two color-opponent dimensions. Exemplary spaces of this form may include IEC 61966-2-1 sYCC, ITU-R Rec. 601 YCbCr, ITU-R Rec. 709 YCbCr, and IEC 61966-2-4 xvYCC. Generally, these opponent color spaces may be defined as a transformation relative to a specified RGB space but also may be specified as a transformation from CIE 1931 XYZ.

Color transformations from a device RGB color space, for example, such as represented by the sensor responses in a digital camera, to arbitrary color spaces may use a transformation to a device-independent color space, for example CIE 1931 XYZ. Such a transformation may be determined using a color characterization process consisting of determining pairs of known XYZ values and corresponding sensor responses. For many sensors this characterization may take the form of a non-linearity that may represent a mapping from device code values to normalized luminance. After applying the non-linearity, the code values may be referred to as linearized RGB. The linearized RGB may commonly be transformed to CIE 1931 XYZ using a 3×3 matrix, but in some cases, this conversion may involve higher-order terms, for example, products of R*G, R*B, B*G, R*R, G*G, B*B and other higher-order terms.

The following describes transforming from intensive-chrominance space to Adobe RGB. The transformation may be derived for the case where sensor RGB have a linear response to light, and in this case, the transformation from sensor RGB, rgb, to CIE XYZ, xyz, may be characterized as:

[XYZ]^{T}=M_{device}_{_{—}}ₜₒ_{_{—}}_{xyz}*[RGB]^{T},

where M_{device}_{_{—}}ₜₒ_{_{—}}_{xyz} may be a 3×3 matrix mapping from linear sensor responses to the CIE XYZ color space. Values in this color conversion matrix may depend on the spectral sensitivity functions of the color sensors.

The AdobeRGB color space may be defined by a linear transformation from CIE XYZ to a set of linearized rgb, RGB_{adobe}=[Rₐ Gₐ Bₐ]:

$${RGB}_{adobe} = {M}_{xyz\_to \_adobergb} * {[ X Y Z ]}^{T}$$

$$where$$

$${M}_{xyz\_to \_adobergb} = [ \begin{matrix}2.04159 & - 0.56501 & - 0.34473 \\ - 0.96924 & 1.87597 & 0.04156 \\ 0.01344 & - 0.11836 & 1.01517\end{matrix} ] .$$

The linearized rgb values may be converted to final output Adobe RGB (1998) values, [R′ G′ B′], and may be computed as:

$${R}^{′} = {R}_{a}^{\frac{1}{2.19921875}} , {G}^{′} = {G}_{a}^{\frac{1}{2.19921875}} , {B}^{′} = {B}_{a}^{\frac{1}{2.19921875}}$$

In some embodiments of the present invention wherein the chrominance is determined 56 by subtraction, the interpolated chrominance signal and the extracted intensive signals may be combined 66 according to:

f_{c1}=f_{I}^{c1}+f_{Ĉ}^{c1},

f_{c2}=f_{I}^{c1c2}+f_{Ĉ}^{c2}

and

f_{c3}=f_{I}^{c1c3}+f_{Ĉ}^{c3},

where f_{c1}, f_{C2} and f_{c3} may be reconstructed color-component images. Conversion to AdobeRGB may be accomplished by converting to linearized AdobeRGB values as according to:

RGb_{adobe}=M_{device}_{_{—}}ₜₒ_{_{—}}_{adobergb}*[f_{c1}f_{c2}f_{c3}]^{T}

where

M_{device}_{_{—}}ₜₒ_{_{—}}_{adobegb}=M_{xyze}_{_{—}}ₜₒ_{_{—}}_{adobergb}*M_{device}_{_{—}}ₜₒ_{_{—}}_{xyz}.

Subsequent application of the AdobeRGB nonlinearity may yield the final output AdobeRGB values.

Alternatively, in some embodiments of the present invention, the interpolated chrominance signals and extracted intensive signals may be converted directly to linearized AdobeRGB values according to:

RGB_{adobe}=M_{lcc}_{_{—}}ₜₒ_{_{—}}_{adobergb}*[f_{I}^{c1}f_{I}^{c1c2}f_{I}^{c1c3}f_{Ĉ}^{c1}f_{Ĉ}^{c1}f_{Ĉ}^{c1}]^{T},

where

M_{lcc}_{_{—}}ₜₒ_{_{—}}_{adobergb}=M_{xyz}_{_{—}}ₜₒ_{_{—}}_{adobergb}*M_{lcc}_{_{—}}ₜₒ_{_{—}}_{xyz},

and where M_{lcc}_{_{—}}ₜₒ_{_{—}}_{xyz} may be a color-conversion matrix determined by a color-characterization process. Subsequent application of the AdobeRGB nonlinearity may yield the final output AdobeRGB values.

In alternative embodiments of the present invention, conversion may be made to a YCbCr color space directly from the interpolated chrominance signals and extracted intensive signals. For the case of IEC 61966-2-1 sYCC, sYCC may be defined as a 3×3 matrix transform on the nonlinear sRGB values, sRGB′. The linear sRGB values may be defined by a 3×3 matrix relative to CIE 1931 XYZ. Thus, the conversion from interpolated chrominance signals and extracted intensive signals to a YCbCr color space may take the form of converting to nonlinear sRGB values according to:

sRGB=M_{lcc}_{_{—}}ₜₒ_{_{—}}_{sRGB}*[f_{I}^{c1}f_{I}^{c1c2}f_{I}^{c1c3}f_{Ĉ}^{c1}f_{Ĉ}^{c1}f_{Ĉ}^{c1}]^{T},

where

M_{lcc}_{_{—}}ₜₒ_{_{—}}_{sRGB}=M_{xyz}_{_{—}}ₜₒ_{_{—}}_{sRGB}*M_{lcc}_{_{—}}ₜₒ_{_{—}}_{xyz},

and wherein conversion of linear sRGB to nonlinear sRGB′ may be made according to:

if R_{sRGB}>0.0031308, then R′_{sRGB}=1.055*(R_{sRGB})^{1/2.4}−0.055

else if −0.0031308≦R_{sRGB}≦0.0031308, then R′_{sRGB}=12.92*R_{sRGB}

else if R_{sRGB}<−0.0031308, then R′_{sRGB}=−1.055*(R_{sRGB})^{1/2.4}+0.55.

A transform to sYCC YCbCr values may be applied to the nonlinear sRGB′ according to:

$${[ Y Cb Cr ]}^{T} = [ \begin{matrix}0.2990 & 0.5870 & 0.1140 \\ - 0.1687 & - 0.3312 & 0.5000 \\ 0.5000 & - 04187 & - 0.0813\end{matrix} ] * {[ {R}^{′} {G}^{′} {B}^{′} ]}^{T} .$$

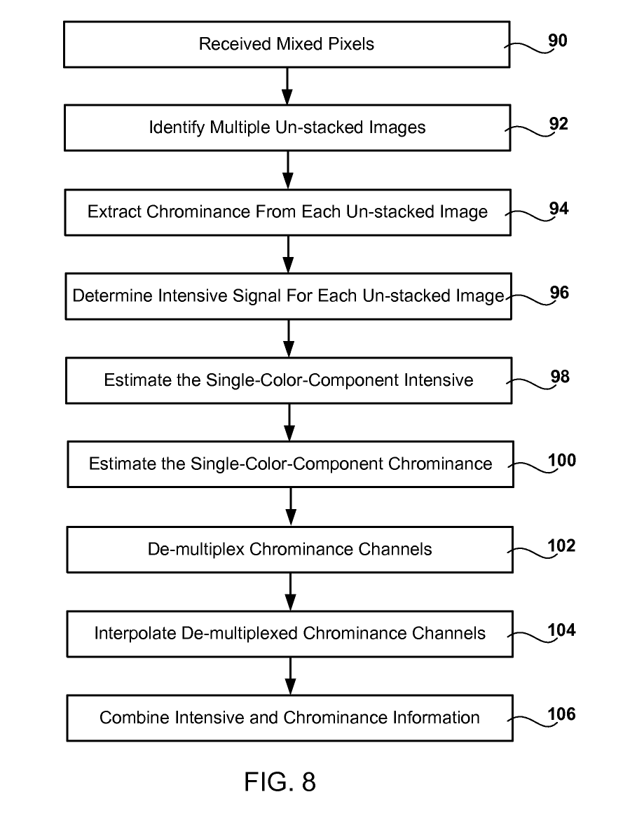

Some embodiments of the present invention comprise methods and systems for frequency-domain-based demosaicing of mixed-pixel-type data. Some of these embodiments may be described in relation to FIG. 8. In these embodiments of the present invention, mixed-pixel-type data may be received 90. The mixed-pixel-type data may comprise single-color-component pixels for which the value of a single color-component may be known and multiple-color-component pixels for which multiple color values corresponding to more than one color-component may be known.

Multiple un-stacked images may be identified 92 from the mixed pixels. In some embodiments of the present invention, each un-stacked image may be associated with a separate buffer, or other memory, and identification 92 of the multiple un-stacked images may comprise separation of the mixed pixels into images with single-valued pixels. In alternative embodiments of the present invention, sensed, mixed-pixel-type data may be stored in a single buffer, or other memory, and an un-stacked image may be processed by indexing the single, sensed-data buffer. In these embodiments, identification 92 of the multiple un-stacked images may comprise the indexing function. In still alternative embodiments of the present invention, sensed, mixed-pixel-type data may be stored in a single buffer or other memory, and a masking function may separate the single-valued pixels associated with un-stacked pixels during the demosaicing, thereby identifying 92 the un-stacked images. Identification 92 of multiple un-stacked images is intended to reflect the decomposition of mixed-pixel-type and stacked-pixel-type data into single-valued pixel data for demosaicing. In some embodiments of the present invention, identification 92 of multiple un-stacked images may be implicit in the processing of the sensed, mixed-pixel-type data.

Each un-stacked image may comprise the single-color-component pixel data and the values associated with one of the color-components of the multiple-color-component pixels. A chrominance signal associated with each un-stacked image may be extracted 94. In some embodiments of the present invention, the chrominance signals may be extracted 94 by applying a chrominance-extraction filter to each of the un-stacked images. In some of these embodiments, the same chrominance-extraction filter may be used for each un-stacked image. In alternative of these embodiments, the chrominance-extraction filter may be specific to the color-component combination of each un-stacked image.

After a chrominance signal is extracted 94 from each un-stacked image, a intensive signal may be determined 96 for each un-stacked image. In some embodiments, the intensive signal may be determined 96 according to:

f_{I}^{unstacked}=f_{[ ]}^{unstacked}−f_{C}^{unstacked},

where f_{[ ]}^{unstacked} denotes an un-stacked image, f_{C}^{unstacked} denotes the extracted chrominance and f_{I}^{unstacked} denotes the intensive signal associated with the un-stacked image. In alternative embodiments, the intensive signal may be determined 96 according to:

$${f}_{I}^{unstacked} = \frac{{f}_{[ ]}^{unstacked}}{{f}_{C}^{unstacked}} .$$

Because the color information associated with the single-color-component pixels may be carried in each un-stacked image, the chrominance signal associated with this color channel may be estimated 100 from the chrominance information extracted 94 from the un-stacked images. In some embodiments of the present invention, the single-color-component chrominance estimate may comprise the average of the chrominance signals. In alternative embodiments, the single-color-component chrominance estimate may comprise the weighted average of the chrominance signals. In some of these embodiments, the weights may be associated with the relative correlation of the color-component channels respectively.

Similarly, the intensive signal associated with the color channel corresponding to the single-color-component pixels may be estimated 98. In some embodiments of the present invention, the single-color-component intensive estimate may comprise the average of the intensive signals. In alternative embodiments, the single-color-component intensive estimate may comprise the weighted average of the intensive signals. In some of these embodiments, the weights may be associated with the relative correlation of the color-component channels respectively.

The chrominance channels may be de-multiplexed 102 according to the CFA associated with the mixed-pixel data, and the missing chrominance values may be interpolated 104. Exemplary interpolation methods comprise bilinear interpolation, linear interpolation, spline interpolation, cubic interpolation, cosine interpolation, Hermite interpolation, polynomial interpolation and other interpolation methods known in the art. The interpolated chrominance information and the intensive information may be combined 106, thereby reconstructing a full-color image.

Some embodiments of the present invention described in relation to FIG. 8 may be illustrated for a pixel arrangement [c1, c2|c3], where c1, c2 and c3 represent three color components, and the received 90 mixed-pixel-type data may be denoted f_{[c1,c2|c3]}.

The mixed-pixel-type data may be un-stacked 92, and the multiple un-stacked images may be denoted f_{[c1,c2|c3]}^{c1c2} and f_{[c1,c2|c3]}^{c1c3}. An un-stacked image may comprise all single-color-component pixels and one of the multiple-color-components of the stacked pixels.

A chrominance signal associated with each un-stacked image may be extracted 94. For the illustrative pixel arrangement [c1, c2|c3], the chrominance associated with the un-stacked images f_{[c1,c2|c3]}^{c1c2} and f_{[c1,c2|c3]}^{c1c3} may be denoted f_{C}^{c1c2} and f_{C}^{c1c2}, respectively. Chrominance extraction 94 may comprise convolution with a chrominance-extraction kernel according to:

f_{C}^{c1c2}=h_{C}^{c1c2}*f_{[c1,c2|c3]}^{c1c2}

and

f_{C}^{c1c3}=h_{C}^{c1c3}*f_{[c1,c2|c3]}^{c1c3},

where * denotes convolution and h_{C}^{c1c2} and h_{C}^{c1c3} may be the chrominance-extraction kernels associated with the color-component combinations c1-c2 and c1-c3, respectively. In some embodiments of the present invention, h_{C}^{c1c2}=h_{C}^{c1c3}=h_{C}.

For the exemplary 2PFC sensor, [G, R|B], two chrominance images may be formed according to:

f_{C}^{GR}=h_{C}^{GR}*f_{[G,R|B]}^{GR}

and

f_{C}^{GB}=h_{C}^{GB}*f_{[G,R|B]}^{GB},

where * denotes convolution and h_{C}^{GR} and h_{C}^{GB} may be the chrominance-extraction kernels associated with the color-component combinations green-red and green-blue, respectively. In some embodiments of the present invention, h_{C}^{GR}=h_{C}^{GB}=h_{C}. In some of these embodiments, a 5×5 filter may be used to extract chrominance.

The frequency response of an exemplary chrominance-extraction filter may be described in relation to the frequency response 80 of the exemplary intensive-extraction filter shown in FIG. 7. The exemplary chrominance-extraction filter may pass frequencies which are suppressed by the exemplary intensive-extraction filter and may suppress those frequencies which are passed by the exemplary intensive-extraction filter.

In some embodiments, after a chrominance signal is extracted 94 from each un-stacked image, an intensive signal may be determined 96 for each un-stacked image according to:

f_{I}^{c1c2}=f_{[c1,c2|c3]}^{c1c2}−f_{C}^{c1c2}

and

f_{I}^{c1c3}=f_{[c1,c2|c3]}^{c1c3}−f_{C}^{c1c3}.

In alternative embodiments, the intensive signals may be determined 96 for each un-stacked image according to:

$${f}_{I}^{c 1 c 2} = \frac{{f}_{[ c 1 , c 2 \vert c 3 ]}^{c 1 c 2}}{{f}_{C}^{c 1 c 2}}$$

$$and$$

$${f}_{I}^{c 1 c 3} = \frac{{f}_{[ c 1 , c 2 \vert c 3 ]}^{c 1 c 3}}{{f}_{C}^{c 1 c 3}} .$$

Because the color information associated with the single-color-component pixels may be carried in each un-stacked image, the chrominance signal associated with this color channel may be estimated 100 from the chrominance information extracted 94 from the un-stacked images. In some embodiments of the present invention, the estimate may be determined according to:

$${f}_{C}^{c 1} = \frac{{f}_{C}^{c 1 c 2} + {f}_{C}^{c 1 c 3}}{2} ,$$

and in alternative embodiments, the estimate may be determined according to:

f_{C}^{c1}=β₂f_{C}^{c1c2}+β₃f_{C}^{c1c3},

where β₂ and β₃ are weights, which, in some embodiments of the present invention, may reflect the relative correlation of the c1-c2 components and the c1-c3 color channels, respectively. In alternative embodiments, the estimate may be determined according to:

$${f}_{C}^{c 1} = {\sum }_{( i , j ) ∈ N} {w}_{C} ( i , j ) {f}_{C}^{c 1 c 2} ( i , j ) + {v}_{C} ( i , j ) {f}_{C}^{c 1 c 3} ( i , j ) ,$$

where N is a neighborhood proximate to the location in f_{C}^{c1} for which the estimate is being calculated and w_{C}(i, j) and v_{C}(i, j) correspond to the weights for the c1-c2 and c1-c3 un-stacked images, respectively.

Similarly, the intensive signal associated with the color channel corresponding to the single-color-component pixels may be estimated 98. In some embodiments of the present invention, the estimate may be determined according to:

$${f}_{I}^{c 1} = \frac{{f}_{I}^{c 1 c 2} + {f}_{I}^{c 1 c 3}}{2} ,$$

and in alternative embodiments, the estimate may be determined according to:

f_{I}^{c1}=α₂f_{I}^{c1c2}+α₃f_{I}^{c1c3},

where α₂ and α₃ are weights, which in some embodiments of the present invention, may reflect the relative correlation of the c1-c2 components and the c1-c3 color channels, respectively. In alternative embodiments, the estimate may be determined according to:

$${f}_{I}^{c 1} = {\sum }_{( i , j ) ∈ N} {w}_{I} ( i , j ) {f}_{I}^{c 1 c 2} ( i , j ) + {v}_{I} ( i , j ) {f}_{I}^{c 1 c 3} ( i , j ) ,$$

where N is a neighborhood proximate to the location in f_{I}^{c1} for which the estimate is being calculated and w_{I}(i, j) and v_{I}(i, j) correspond to the weights for the c1-c2 and c1-c3 un-stacked images, respectively.

Letting C={f_{C}^{c1c2}; f_{C}^{c1}; f_{C}^{c1c3}} denote the 3-channel, multiplexed chrominance values, the chrominance channels may be de-multiplexed 102 according to the CFA associated with the mixed-pixel data, and the missing chrominance values may be interpolated 104. Exemplary interpolation methods comprise bilinear interpolation, linear interpolation, spline interpolation, cubic interpolation, cosine interpolation, Hermite interpolation, polynomial interpolation and other interpolation methods known in the art. The interpolated chrominance channels may be denoted f_{Ĉ}^{c1}, f_{Ĉ}^{c2} and f_{Ĉ}^{c3}. In embodiments of the present invention wherein the intensive signal may be determined 96 by subtraction, the interpolated chrominance information and the intensive information may be combined 106 according to:

f_{c1}=f_{Ĉ}^{c1}+f_{I}^{c1},

f_{c2}=f_{Ĉ}^{c2}+f_{I}^{c1c2}

and

f_{c3}=f_{Ĉ}^{c3}+f_{I}^{c1c3},

where f_{c1}, f_{c2} and f_{c3} are reconstructed color-component images. In alternative embodiments wherein the intensive information may be determined 96 by a ratio, the interpolated chrominance and the intensive information may be combined 106 according to:

f_{c1}=f_{Ĉ}^{c1}+f_{I}^{c1},

f_{c2}=f_{Ĉ}^{c2}+f_{I}^{c1c2}

and

f_{c3}=f_{Ĉ}^{c3}+f_{I}^{c1c3}.

Some embodiments of the present invention may comprise one, or more, intensive-extraction filters. An intensive-extraction filter may be designed according to filter-design methods known in the art. Exemplary methods may include least-squares, and other error minimization, formulations, hand design of a 2D filter with the desired response and approximation of the filter by a fixed-size kernel, iterative filter design methods and other methods. In some embodiments of the present invention, the intensive-extraction filter, or filters, may be computed according to a least-squares formulation:

h_{I}=arg minₕE[(f_{I}−h*f_{CFA})²]

where f_{CFA} is the CFA image and f_{I} the intensive image. In some embodiments, the error may be minimized over a training set of full-color images and f_{I} is thus known.

Some embodiments of the present invention may comprise one, or more, chrominance-extraction filters. A chrominance-extraction filter may be designed according to filter-design methods known in the art. Exemplary methods may include least-squares, and other error minimization, formulations, hand design of a 2D filter with the desired response and approximation of the filter by a fixed-size kernel, iterative filter design methods and other methods. In some embodiments of the present invention, the chrominance-extraction filter, or filters, may be computed according to a least-squares formulation:

h_{C}=arg minₕE[(f_{C}−h*f_{CFA})²]

where f_{CFA} is the CFA image and f_{C} the chrominance image. In some embodiments, the error may be minimized over a training set of full-color images and f_{C} is thus known.

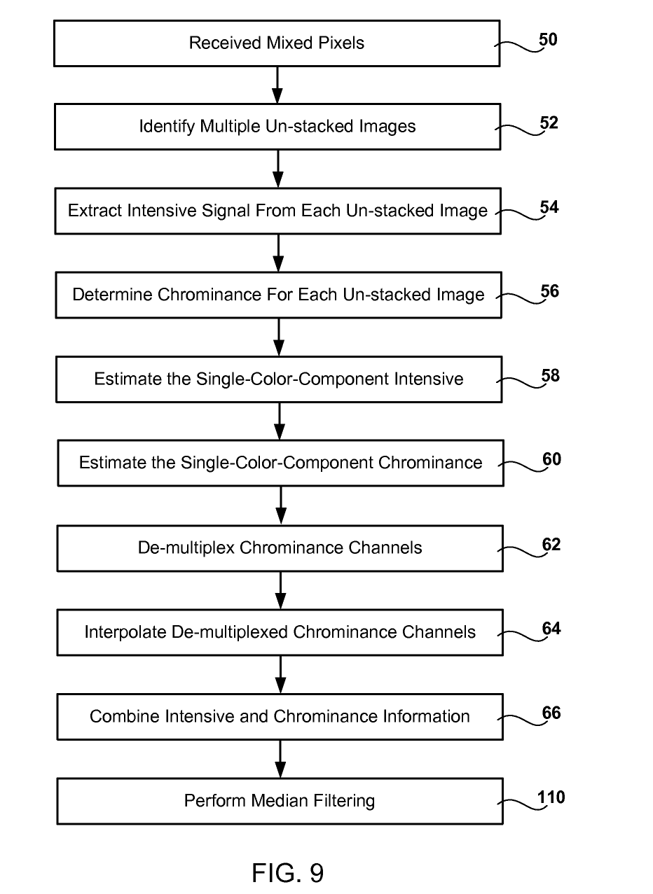

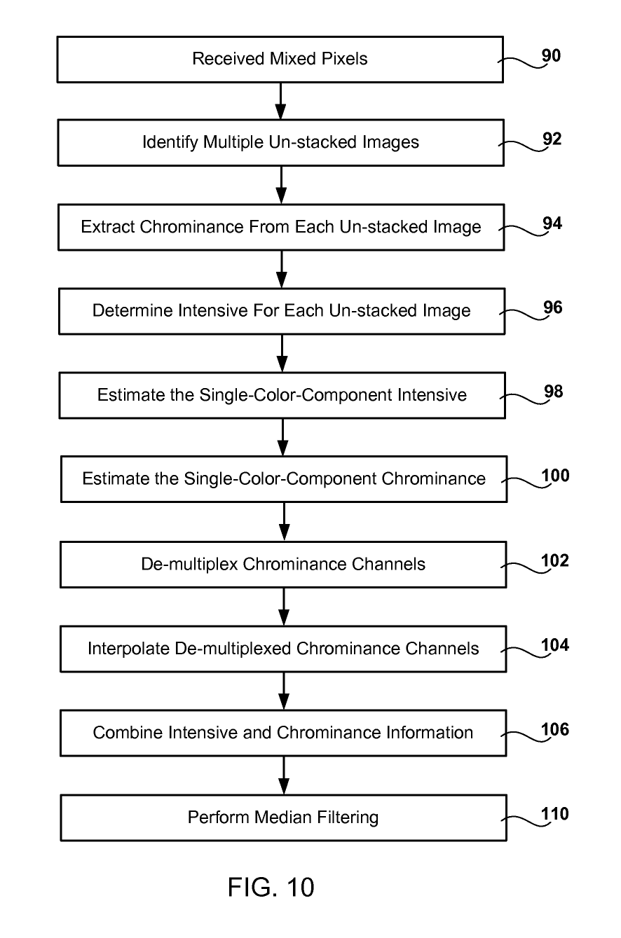

In some embodiments of the present invention described in relation to FIG. 9 and FIG. 10, a reconstructed full-color image may be median filtered 110 after demosaicing. Color differences may vary slowly, and small variations in color may be suppressed by median filtering. Accordingly, in some of these embodiments, median filtering 110 may be performed on color differences. In some embodiments of the present invention, median filtering 110 may comprise a 3×3 kernel. In some embodiments of the present invention, the median filter 110 may be applied only to the reconstructed pixels. In alternative embodiments, the median filter 110 may be applied to all pixels. In some embodiments of the present invention, the R channel may be computed first, followed by the B channel and finally the G channel. The three channels may be computed according to:

$$R = G + median ( R - G ) , \\ B = G + median ( B - G )$$

$$and$$

$$G = \frac{1}{2} [ R + median ( R - G ) + b + median ( B - G ) ] .$$

In some embodiments of the present invention, the median filtering 110 may be applied once. In alternative embodiments of the present invention, the median filtering 110 may be sequentially applied multiple times.

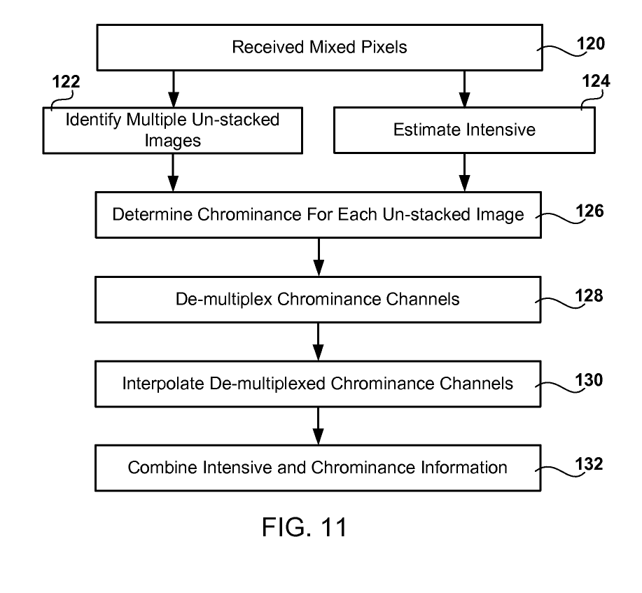

In some embodiments of the present invention described in relation to FIG. 11, mixed-pixel-type data may be received 120. Multiple un-stacked images may be identified 122 from the mixed pixels, and an intensive signal may be estimated directly from the mixed-pixel-type data 124. In some embodiments of the present invention, each un-stacked image may be associated with a separate buffer, or other memory, and identification 122 of the multiple un-stacked images may comprise separation of the mixed pixels into images with single-valued pixels. In alternative embodiments of the present invention, sensed, mixed-pixel-type data may be stored in a single buffer, or other memory, and an un-stacked image may be processed by indexing the single, sensed-data buffer. In these embodiments, identification 122 of the multiple un-stacked images may comprise the indexing function. In still alternative embodiments of the present invention, sensed, mixed-pixel-type data may be stored in a single buffer or other memory, and a masking function may separate the single-valued pixels associated with un-stacked pixels during the demosaicing, thereby identifying 122 the un-stacked images. Identification 122 of multiple un-stacked images is intended to reflect the decomposition of mixed-pixel-type and stacked-pixel-type data into single-valued pixel data for demosaicing. In some embodiments of the present invention, identification 122 of multiple un-stacked images may be implicit in the processing of the sensed, mixed-pixel-type data.

In some embodiments of the present invention, the intensive estimate may be generated as a weighted combination of the mixed-pixel data within a neighborhood, N, according to:

$${f}_{I} = {\sum }_{i ∈ N b}^{ } w ( i ) {f}_{[ ]} ( i ) .$$

After the intensive signal is estimated 124, a chrominance signal may be determined 126 for each un-stacked image. In some embodiments, a chrominance signal associated with an un-stacked image may be determined 126 by subtracting the intensive estimate from the un-stacked image according to:

f_{C}^{unstacked}=f_{[ ]}^{unstacked}−f_{I}.

In alternative embodiments, the chrominance signal may be determined 126 according to:

$${f}_{C}^{unstacked} = \frac{{f}_{[ ]}^{unstacked}}{{f}_{I}} .$$

The 3-channel, multiplexed chrominance values may be de-multiplexed 128 according to the CFA associated with the mixed-pixel data, and the missing chrominance values may be interpolated 130. Exemplary interpolation methods comprise bilinear interpolation, linear interpolation, spline interpolation, cubic interpolation, cosine interpolation, Hermite interpolation, polynomial interpolation and other interpolation methods known in the art.

The interpolated chrominance channels may be denoted f_{Ĉ}^{c1}, f_{Ĉ}^{c2}, and f_{Ĉ}^{c3}. In embodiments wherein the chrominance signals may be determined 126 by subtraction, the interpolated chrominance information and the estimated intensive information may be combined 132 according to:

f_{c1}=f_{I}^{c1}+f_{Ĉ}^{c1},

f_{c2}=f_{I}^{c1c2}+f_{Ĉ}^{c2}

and

f_{c3}=f_{I}^{c1c3}+f_{Ĉ}^{c3},

where f_{c1}, f_{C2} and f_{C3} are reconstructed color-component images and f_{I} may be the intensive estimated from the mixed-pixel data. In alternative embodiments wherein the chrominance signals may be determined 126 according to a ratio, the interpolated chrominance information and the estimated intensive information may be combined 132 according to:

f_{c1}=f_{I}×f_{Ĉ}^{c1},

f_{c2}=f_{I}×f_{Ĉ}^{c2}

and

f_{c3}=f_{I}×f_{Ĉ}^{c3},

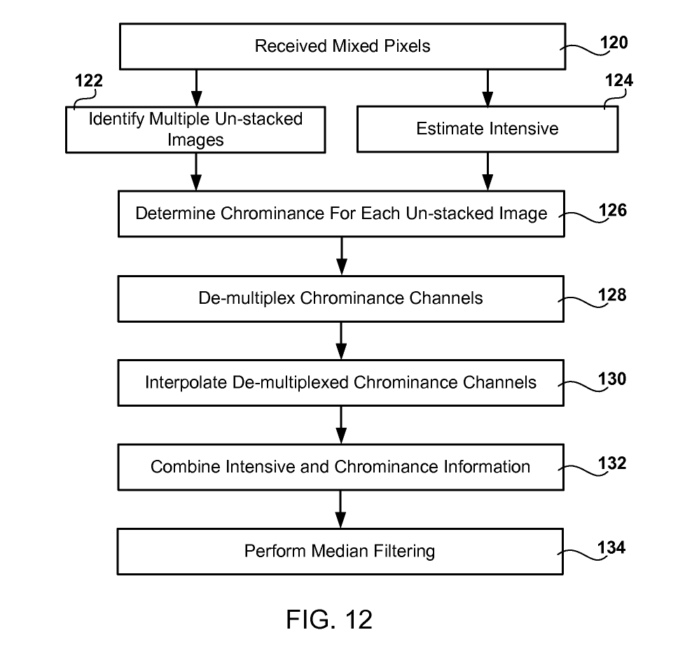

Some embodiments of the present invention described in relation to FIG. 12 comprise median filtering 134 after full-color image reconstruction.

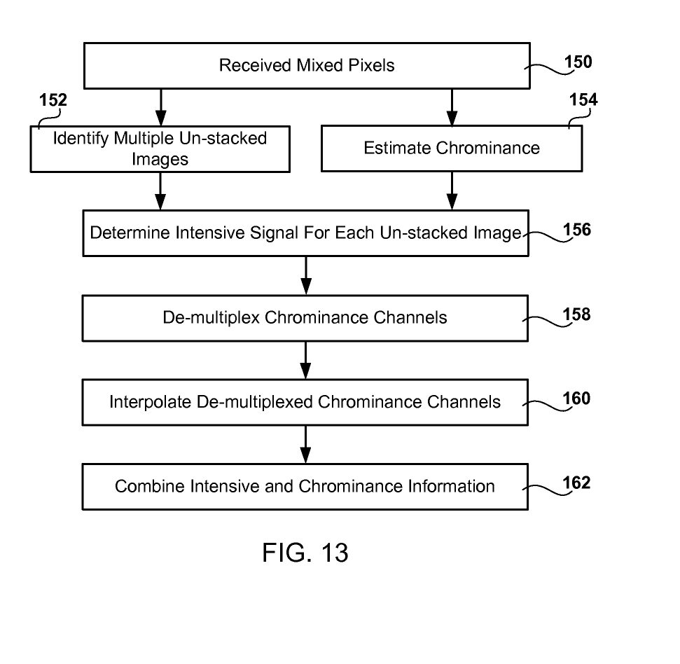

In some embodiments of the present invention described in relation to FIG. 13, mixed-pixel-type data may be received 150. Multiple un-stacked images may be identified 152 from the mixed pixels, and a chrominance signal may be estimated directly from the mixed-pixel data 154. In some embodiments of the present invention, each un-stacked image may be associated with a separate buffer, or other memory, and identification 152 of the multiple un-stacked images may comprise separation of the mixed pixels into images with single-valued pixels. In alternative embodiments of the present invention, sensed, mixed-pixel-type data may be stored in a single buffer, or other memory, and an un-stacked image may be processed by indexing the single sensed-data buffer. In these embodiments, identification 152 of the multiple un-stacked images may comprise the indexing function. In still alternative embodiments of the present invention, sensed, mixed-pixel-type data may be stored in a single buffer or other memory, and a masking function may separate the single-valued pixels associated with un-stacked pixels during the demosaicing, thereby identifying 152 the un-stacked images. Identification 152 of multiple un-stacked images is intended to reflect the decomposition of mixed-pixel-type and stacked-pixel-type data into single-valued pixel data for demosaicing. In some embodiments of the present invention, identification 152 of multiple un-stacked images may be implicit in the processing of the sensed, mixed-pixel-type data.

In some embodiments of the present invention, a chrominance estimate may be generated as a weighted combination of the mixed-pixel-type data within a neighborhood, N, according to:

$${f}_{C} = {\sum }_{i ∈ N} w ( i ) {f}_{[ ]} ( i ) .$$

After the chrominance is estimated 154, an intensive signal may be determined 156 for each un-stacked image. In some embodiments, the intensive may be determined 156 by subtracting the chrominance estimate from each un-stacked image according to:

f_{I}^{unstacked}=f_{[ ]}^{unstacked}−f_{C}.

In alternative embodiments, the intensive may be determined 156 according to:

$${f}_{I}^{unstacked} = \frac{{f}_{[ ]}^{unstacked}}{{f}_{C}} .$$

The 3-channel, multiplexed chrominance values may be de-multiplexed 158 according to the CFA associated with the mixed-pixel data, and the missing chrominance values may be interpolated 160. Exemplary interpolation methods comprise bilinear interpolation, linear interpolation, spline interpolation, cubic interpolation, cosine interpolation, Hermite interpolation, polynomial interpolation and other interpolation methods known in the art. The interpolated chrominance channels may be denoted f_{Ĉ}^{c1}, f_{Ĉ}^{c2} and f_{Ĉ}^{c3}.

In embodiments wherein the intensive signals may be determined 156 using subtraction, the interpolated chrominance signal and the intensive information may be combined, for the exemplary sensor arrangement [c1, c2|c3], 162 according to:

f_{c1}=f_{Ĉ}^{c1}+f_{I}^{c1},

f_{c2}=f_{Ĉ}^{c2}+f_{I}^{c1c2}

and

f_{c3}=f_{Ĉ}^{c3}+f_{I}^{c1c3},

where f_{c1}, f_{c2} and f_{c3} are reconstructed color-component images. In alternative embodiments wherein the intensive signals may be determined 156 according to a ratio, the interpolated chrominance and the intensive information may be combined 162 according to:

f_{c1}=f_{Ĉ}^{c1}×f_{I}^{c1},

f_{c2}=f_{Ĉ}^{c2}×f_{I}^{c1c2}

and

f_{c3}=f_{Ĉ}^{c3}×f_{I}^{c1c3},

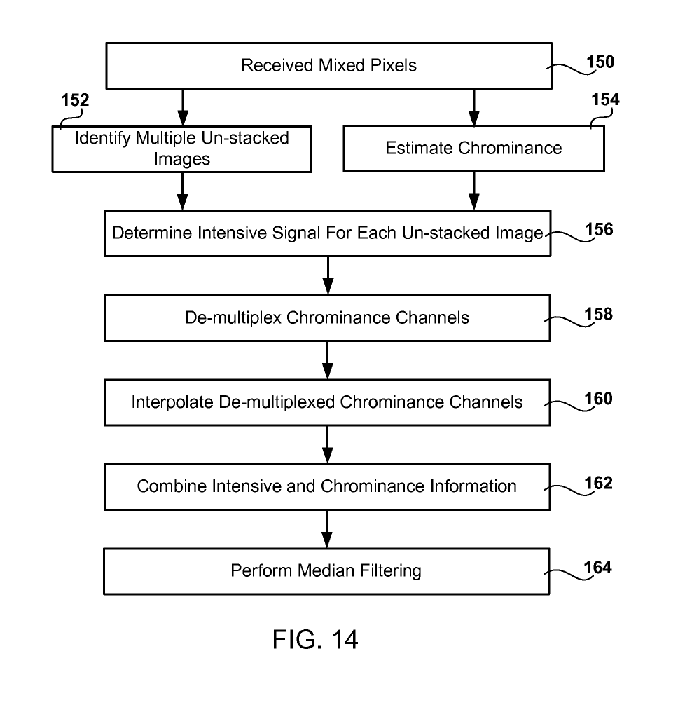

Some embodiments of the present invention described in relation to FIG. 14 comprise median filtering 164 after full-color image reconstruction.

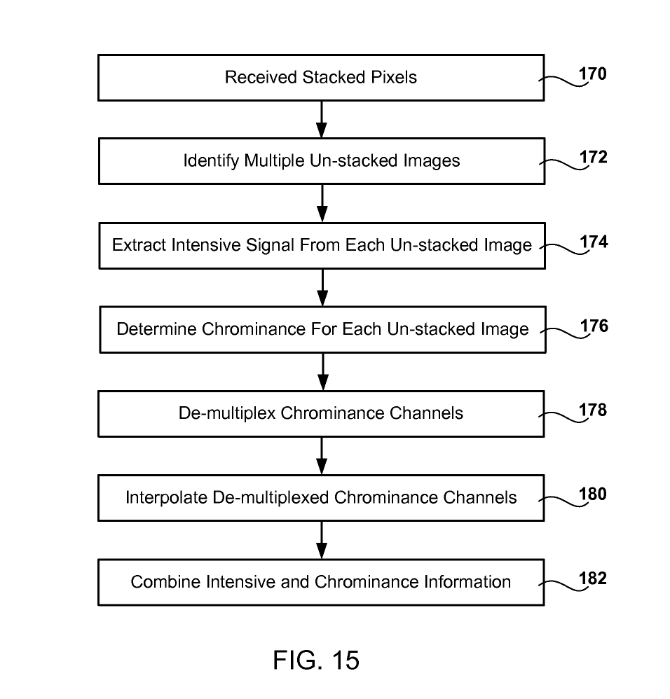

Some embodiments of the present invention comprise methods and systems for frequency-domain-based demosaicing of stacked-pixel-type data, wherein each pixel comprises multiple color-component values. Some of these embodiments may be described in relation to FIG. 15. In these embodiments of the present invention, stacked-pixel-type data may be received 170.

Multiple un-stacked images may be identified 172 from the stacked pixels. In some embodiments of the present invention, each un-stacked image may be associated with a separate buffer, or other memory, and identification 172 of the multiple un-stacked images may comprise separation of the stacked pixels into images with single-valued pixels. In alternative embodiments of the present invention, sensed, stacked-pixel-type data may be stored in a single buffer, or other memory, and an un-stacked image may be processed by indexing the single sensed-data buffer. In these embodiments, identification 172 of the multiple un-stacked images may comprise the indexing function. In still alternative embodiments of the present invention, sensed, stacked-pixel-type data may be stored in a single buffer or other memory, and a masking function may separate the single-valued pixels associated with un-stacked pixels during the demosaicing, thereby identifying 172 the un-stacked images. Identification 172 of multiple un-stacked images is intended to reflect the decomposition of mixed-pixel-type and stacked-pixel-type data into single-valued pixel data for demosaicing. In some embodiments of the present invention, identification 172 of multiple un-stacked images may be implicit in the processing of the sensed, stacked-pixel-type data.

There may be more than one way of forming 172 un-stacked images from the stacked pixels. This may be illustrated by the exemplary tiling [G|R, G|B], wherein the pixels in an image may be comprised of a first group of stacked pixels with green and red color-component values and a second group of stacked pixels with green and blue color-component values. In some embodiments of the present invention, the stacked pixels may be un-stacked to form a first image corresponding to [G, G] and a second image corresponding to [R, B]. In alternative embodiments of the present invention, the stacked pixels may be un-stacked to form a first image corresponding to [G, B] and a second image corresponding to [R, G]. In yet alternative embodiments of the present invention, the different pixel types may have different G responses due to spectral filtering differences between the pixels. In these embodiments, the tiling may be [G′|R, G″|B], wherein G′ and G″ denote the different responses. In these embodiments, a common [G, G] image may be estimated as a weighted combination of G′ and G″ values.

An intensive signal associated with each un-stacked image may be extracted 174. In some embodiments of the present invention, the intensive signal may be extracted 174 by applying a intensive-extraction filter to each of the un-stacked images. In some of these embodiments, the same intensive-extraction filter may be used for each un-stacked image. In alternative of these embodiments, the intensive-extraction filter may be specific to the color-component combination of each un-stacked image.

After an intensive signal is extracted 174 from each un-stacked image, a chrominance signal may be determined 176 for each un-stacked image. In some embodiments of the present invention, a chrominance signal may be determined 176 according to:

f_{C}^{unstacked}=f_{[ ]}^{unstacked}−f_{I}^{unstacked},

where f_{[ ]}^{unstacked} denotes an un-stacked image, f_{I}^{unstacked} denotes the extracted intensive associated with the un-stacked image and f_{C}^{unstacked} denotes the chrominance associated with the un-stacked image. In alternative embodiments, the chrominance signal may be determined 176 according to:

$${f}_{C}^{unstacked} = \frac{{f}_{[ ]}^{unstacked}}{{f}_{I}^{unstacked}} .$$

In some embodiments of the present invention, the color information associated with one of the color components may be carried in multiple un-stacked images. An intensive associated with this color channel may be estimated from the intensive information extracted 174 from the un-stacked images. In some embodiments of the present invention, the intensive estimate may comprise the average of the intensive signals associated with each un-stacked image in which the color component is present. In alternative embodiments, the intensive estimate may comprise the weighted average of these intensive signals. In some of these embodiments, the weights may be associated with the relative correlation of the color-component channels respectively. In some embodiments of the present invention, a color shift may be introduced by the weighted average, and a color-correction may be applied to compensate for the color shift.

A chrominance associated with the color component may be present in more than one un-stacked image and may be estimated. In some embodiments of the present invention, the chrominance estimate may comprise the average of the chrominance signals associated with each un-stacked image in which the color component is present. In alternative embodiments, the chrominance estimate may comprise the weighted average of the chrominance signals. In some of these embodiments, the weights may be associated with the relative correlation of the color-component channels respectively. In some embodiments of the present invention, a color shift may be introduced by the weighted average, and a color-correction may be applied to compensate for the color shift.

The chrominance channels may be de-multiplexed 178 according to the CFA associated with the stacked-pixel-type data, and missing chrominance values may be interpolated 180. Exemplary interpolation methods comprise bilinear interpolation, linear interpolation, spline interpolation, cubic interpolation, cosine interpolation, Hermite interpolation, polynomial interpolation and other interpolation methods known in the art.

The interpolated chrominance information and the estimated intensive information may be combined 182, thereby reconstructing a full-color image. In embodiments of the present invention wherein the chrominance signals may be determined 176 using subtraction, combining 182 the estimated intensive information and the interpolated chrominance information may comprise adding the estimated intensive information and the interpolated chrominance information. In alternative embodiments wherein the chrominance signals may be determined 176 using a ratio, combining 182 the estimated intensive information and the interpolated chrominance information may comprise multiplication.

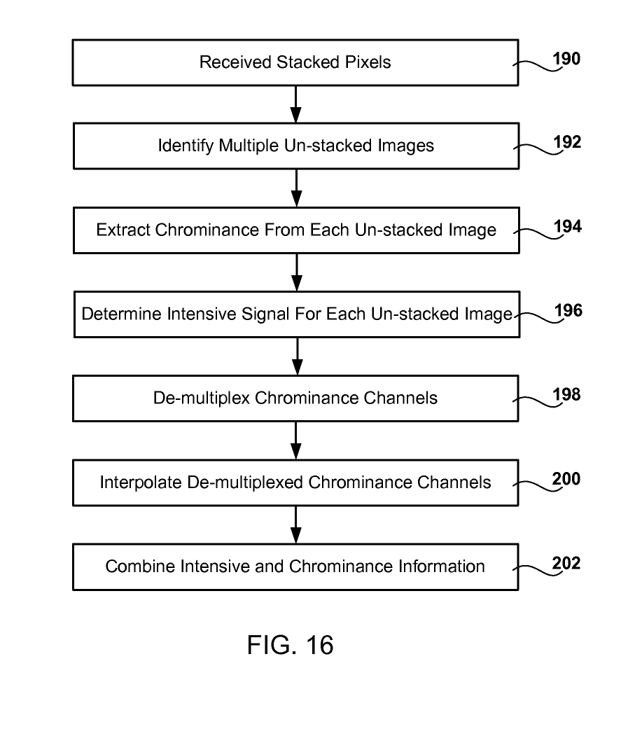

Alternative embodiments of the present invention may be described in relation to FIG. 16. In these embodiments of the present invention, stacked-pixel-type data may be received 190. Multiple un-stacked images may be identified 192 from the stacked pixels. In some embodiments of the present invention, each un-stacked image may be associated with a separate buffer, or other memory, and identification 192 of the multiple un-stacked images may comprise separation of the stacked pixels into images with single-valued pixels. In alternative embodiments of the present invention, sensed, stacked-pixel-type data may be stored in a single buffer, or other memory, and an un-stacked image may be processed by indexing the single sensed-data buffer. In these embodiments, identification 192 of the multiple un-stacked images may comprise the indexing function. In still alternative embodiments of the present invention, sensed, stacked-pixel-type data may be stored in a single buffer, or other memory, and a masking function may separate the single-valued pixels associated with un-stacked pixels during the demosaicing, thereby identifying 192 the un-stacked images. Identification 192 of multiple un-stacked images is intended to reflect the decomposition of mixed-pixel-type and stacked-pixel-type data into single-valued pixel data for demosaicing. In some embodiments of the present invention, identification 192 of multiple un-stacked images may be implicit in the processing of the sensed, stacked-pixel-type data.

There may be more than one way of forming 192 un-stacked images from the stacked pixels. This may be illustrated by the exemplary tiling [G|R, G|B], wherein the pixels in an image may be comprised of a first group of stacked pixels with green and red color-component values and a second group of stacked pixels with green and blue color-component values. In some embodiments of the present invention, the stacked pixels may be un-stacked to form a first image corresponding to [G, G] and a second image corresponding to [R, B]. In alternative embodiments of the present invention, the stacked pixels may be un-stacked to form a first image corresponding to [G, B] and a second image corresponding to [R, G]. In yet alternative embodiments of the present invention, the different pixel types may have different G responses due to spectral filtering differences between the pixels. In these embodiments, the tiling may be [G′|R, G″|B], wherein G′ and G″ denote the different responses. In these embodiments, a common [G, G] image may be estimated as a weighted combination of G′ and G″ values.

A chrominance signal associated with each un-stacked image may be extracted 194. In some embodiments of the present invention, the chrominance may be extracted 194 by applying a chrominance-extraction filter to each of the un-stacked images. In some of these embodiments, the same chrominance-extraction filter may be used for each un-stacked image. In alternative of these embodiments, the chrominance-extraction filter may be specific to the color-component combination of each un-stacked image.

After the chrominance is extracted 194 from each un-stacked image, an intensive signal may be determined 196 for each un-stacked image. In some embodiments of the present invention, the intensive signal associated with an un-stacked image may be determined 196 according to:

f_{I}^{unstacked}=f_{[ ]}^{unstacked}−f_{C}^{unstacked},

where f_{[ ]}^{unstacked} denotes an un-stacked image, f_{C}^{unstacked} denotes the extracted chrominance and f_{I}^{unstacked} denotes the intensive associated with the un-stacked image. In alternative embodiments, the intensive signal associated with an un-stacked image may be determined 196 according to:

$${f}_{I}^{unstacked} = \frac{{f}_{[ ]}^{unstacked}}{{f}_{C}^{unstacked}} .$$

In some embodiments of the present invention, the color information associated with one of the color components may be carried in multiple un-stacked images. A chrominance associated with this color channel may be estimated from the chrominance information extracted 194 from the un-stacked images. In some embodiments of the present invention, the chrominance estimate may comprise the average of the chrominance signals associated with each un-stacked image in which the color component is present. In alternative embodiments, the chrominance estimate may comprise the weighted average of these chrominance signals. In some of these embodiments, the weights may be associated with the relative correlation of the color-component channels respectively. In some embodiments of the present invention, a color shift may be introduced by the weighted average, and a color correction may be applied to compensate for the color shift.

An intensive signal associated with a color component may be present in more than one un-stacked image and may be estimated. In some embodiments of the present invention, the intensive estimate may comprise the average of the intensive signals associated with each un-stacked image in which the color component is present. In alternative embodiments, the intensive estimate may comprise the weighted average of the intensive signals. In some of these embodiments, the weights may be associated with the relative correlation of the color-component channels respectively. In some embodiments of the present invention, a color shift may be introduced by the weighted average, and a color correction may be applied to compensate for the color shift.

The chrominance channels may be de-multiplexed 198 according to the CFA associated with the stacked-pixel data, and missing chrominance values may be interpolated 200. Exemplary interpolation methods comprise bilinear interpolation, linear interpolation, spline interpolation, cubic interpolation, cosine interpolation, Hermite interpolation, polynomial interpolation and other interpolation methods known in the art.

The intensive and interpolated chrominance information may be combined 202, thereby reconstructing a full-color image. In embodiments of the present invention wherein the intensive signals may be determined 196 using subtraction, combining 202 the interpolated chrominance information and the intensive information may comprise adding the interpolated chrominance information and the intensive information. In alternative embodiments wherein the intensive signals may be determined 196 using a ratio, combining 202 the interpolated chrominance information and the intensive information may comprise multiplication.

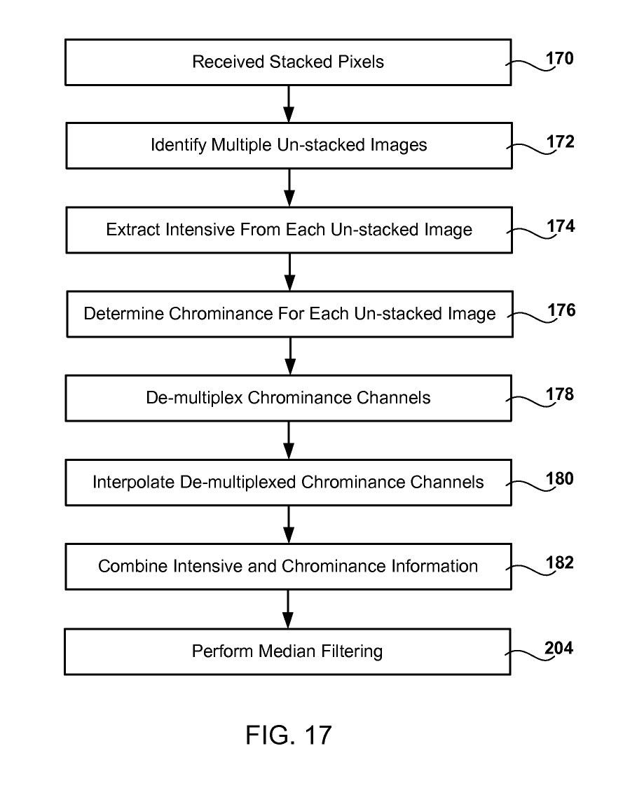

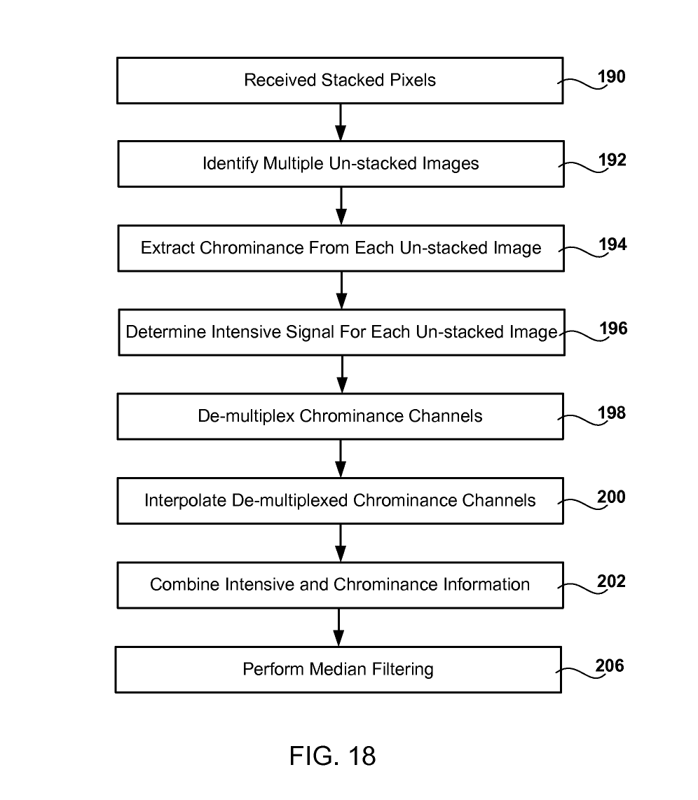

In some embodiments of the present invention described in relation to FIG. 17 and FIG. 18, median filtering 204, 206 may be performed after full-color image reconstruction.

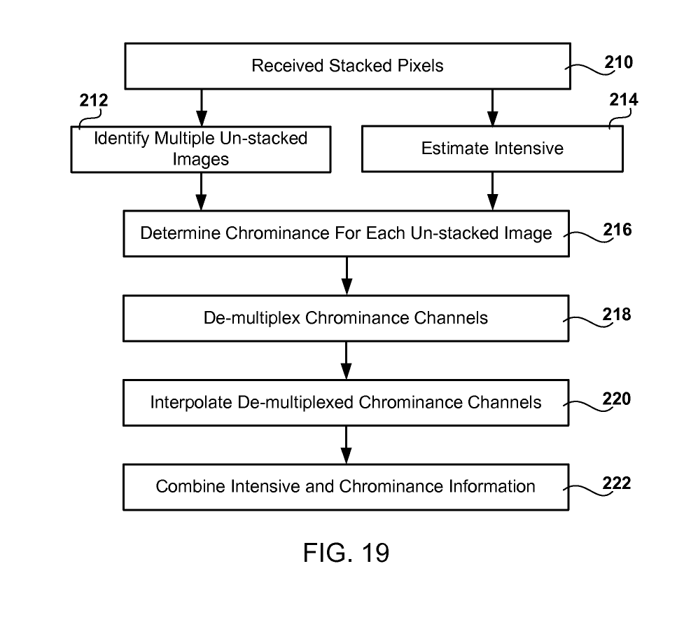

Alternative embodiments of the present invention may be described in relation to FIG. 19. In these embodiments of the present invention, stacked-pixel-type data may be received 210. Multiple un-stacked images may be identified 212 from the stacked pixels. In some embodiments of the present invention, each un-stacked image may be associated with a separate buffer, or other memory, and identification 212 of the multiple un-stacked images may comprise separation of the stacked pixels into images with single-valued pixels. In alternative embodiments of the present invention, sensed, stacked-pixel-type data may be stored in a single buffer, or other memory, and an un-stacked image may be processed by indexing the single sensed-data buffer. In these embodiments, identification 212 of the multiple un-stacked images may comprise the indexing function. In still alternative embodiments of the present invention, sensed, stacked-pixel-type data may be stored in a single buffer or other memory, and a masking function may separate the single-valued pixels associated with un-stacked pixels during the demosaicing, thereby identifying 212 the un-stacked images. Identification 212 of multiple un-stacked images is intended to reflect the decomposition of mixed-pixel-type and stacked-pixel-type data into single-valued pixel data for demosaicing. In some embodiments of the present invention, identification 212 of multiple un-stacked images may be implicit in the processing of the sensed, stacked-pixel-type data.

There may be more than one way of forming 212 un-stacked images from the stacked pixels. This may be illustrated by the exemplary tiling [G|R, G|B], wherein the pixels in an image may be comprised of a first group of stacked pixels with green and red color-component values and a second group of stacked pixels with green and blue color-component values. In some embodiments of the present invention, the stacked pixels may be un-stacked to form a first image corresponding to [G, G] and a second image corresponding to [R, B]. In alternative embodiments of the present invention, the stacked pixels may be un-stacked to form a first image corresponding to [G, B] and a second image corresponding to [R, G]. In yet alternative embodiments of the present invention, the different pixel types may have different G responses due to spectral filtering differences between the pixels. In these embodiments, the tiling may be [G′|R, G″|B], wherein G′ and G″ denote the different responses. In these embodiments, a common [G, G] image may be estimated as a weighted combination of G′ and G″ values.

In some embodiments of the present invention described in relation to FIG. 19, an intensive signal may be estimated 214 directly from the stacked-pixel-type data.

In some embodiments of the present invention, the intensive estimate may be generated 214 as a weighted combination of the stacked-pixel-type data within a neighborhood, N, according to:

$${f}_{I} = {\sum }_{i ∈ N} w ( i ) {f}_{[ ]} ( i ) .$$

After the intensive is estimated 214, a chrominance signal may be determined 216 for each un-stacked image. In some embodiments, the chrominance may be determined 216 by subtracting the intensive estimate from each un-stacked image according to:

f_{C}^{unstacked}=f_{[ ]}^{unstacked}−f_{I}^{unstacked}.

In alternative embodiments, the chrominance may be determined 216 according to:

$${f}_{C}^{unstacked} = \frac{{f}_{[ ]}^{unstacked}}{{f}_{I}} .$$

The 3-channel, multiplexed chrominance values may be de-multiplexed 218 according to the CFA associated with the stacked-pixel data, and the missing chrominance values may be interpolated 220. Exemplary interpolation methods comprise bilinear interpolation, linear interpolation, spline interpolation, cubic interpolation, cosine interpolation, Hermite interpolation, polynomial interpolation and other interpolation methods known in the art. The interpolated chrominance channels may be denoted f_{Ĉ}^{c1}, f_{Ĉ}^{c2} and f_{Ĉ}^{c3}.

In embodiments wherein the chrominance signals may be determined 216 by subtraction, the interpolated chrominance information and the estimated intensive information may be combined 222 according to:

f_{c1}=f_{I}+f_{Ĉ}^{c1},

f_{c2}=f_{I}+f_{Ĉ}^{c2}

and

f_{c3}=f_{I}+f_{Ĉ}^{c3},

where f_{C1}, f_{C2} and f_{C3} are reconstructed color-component images and f_{I} may be the intensive estimated from the mixed-pixel data. In alternative embodiments wherein the chrominance signals may be determined 216 according to a ratio, the interpolated chrominance information and the estimated intensive information may be combined 222 according to:

f_{c1}=f_{I}×f_{Ĉ}^{c1},

f_{c2}=f_{I}×f_{Ĉ}^{c2}

and

f_{c3}=f_{I}×f_{Ĉ}^{c3}.

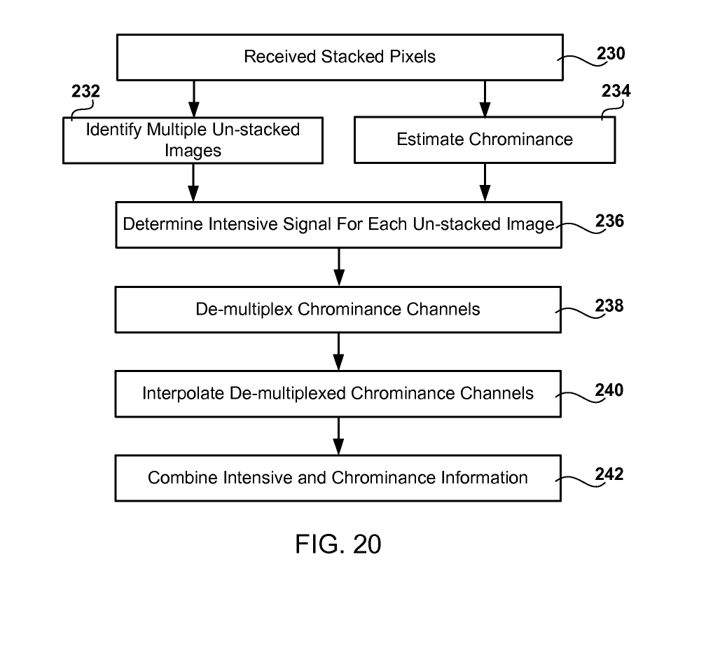

Alternative embodiments of the present invention may be described in relation to FIG. 20. In these embodiments of the present invention, stacked-pixel-type data may be received 230. Multiple un-stacked images may be identified 232 from the stacked pixels. In some embodiments of the present invention, each un-stacked image may be associated with a separate buffer, or other memory, and identification 232 of the multiple un-stacked images may comprise separation of the stacked pixels into images with single-valued pixels. In alternative embodiments of the present invention, sensed, stacked-pixel-type data may be stored in a single buffer, or other memory, and an un-stacked image may be processed by indexing the single sensed-data buffer. In these embodiments, identification 232 of the multiple un-stacked images may comprise the indexing function. In still alternative embodiments of the present invention, sensed, stacked-pixel data may be stored in a single buffer or other memory, and a masking function may separate the single-valued pixels associated with un-stacked pixels during the demosaicing, thereby identifying 232 the un-stacked images. Identification 232 of multiple un-stacked images is intended to reflect the decomposition of mixed-pixel-type and stacked-pixel-type data into single-valued pixel data for demosaicing. In some embodiments of the present invention, identification 232 of multiple un-stacked images may be implicit in the processing of the sensed, stacked-pixel-type data.

There may be more than one way of forming 232 un-stacked images from the stacked pixels. This may be illustrated by the exemplary tiling [G|R, G|B], wherein the pixels in an image may be comprised of a first group of stacked pixels with green and red color-component values and a second group of stacked pixels with green and blue color-component values. In some embodiments of the present invention, the stacked pixels may be un-stacked to form a first image corresponding to [G, G] and a second image corresponding to [R, B]. In alternative embodiments of the present invention, the stacked pixels may be un-stacked to form a first image corresponding to [G, B] and a second image corresponding to [R, G]. In yet alternative embodiments of the present invention, the different pixel types may have different G responses due to spectral filtering differences between the pixels. In these embodiments, the tiling may be [G′|R, G″|B], wherein G′ and G″ denote the different responses. In these embodiments, a common [G, G] image may be estimated as a weighted combination of G′ and G″ values.

In some embodiments of the present invention described in relation to FIG. 20, a chrominance signal may be estimated 234 directly from the stacked-pixel data.

In some embodiments of the present invention, the chrominance estimate may be generated 234 as a weighted combination of the stacked-pixel data within a neighborhood, N, according to:

$${f}_{C} = {\sum }_{i ∈ N} w ( i ) {f}_{[ ]} ( i ) .$$

After the chrominance is estimated 234, an intensive signal may be determined 236 for each un-stacked image. In some embodiments, the intensive signal may be determined 236 by subtracting the chrominance estimate from each un-stacked image according to:

f_{I}^{unstacked}=f_{[ ]}^{unstacked}−f_{C}^{unstacked}.

In alternative embodiments, the intensive signal may be determined 236 according to:

$${f}_{I}^{unstacked} = \frac{{f}_{[ ]}^{unstacked}}{{f}_{C}} .$$

The 3-channel, multiplexed chrominance values may be de-multiplexed 238 according to the CFA associated with the stacked-pixel data, and the missing chrominance values may be interpolated 240. Exemplary interpolation methods comprise bilinear interpolation, linear interpolation, spline interpolation, cubic interpolation, cosine interpolation, Hermite interpolation, polynomial interpolation and other interpolation methods known in the art. The interpolated chrominance channels may be denoted f_{Ĉ}^{c1}, f_{Ĉ}^{c2} and f_{Ĉ}^{c3}.

In embodiments wherein the intensive signals may be determined 236 by subtraction, the intensive information and the interpolated chrominance information may be combined 242 using addition. In alternative embodiments wherein the intensive signals may be determined 236 according to a ratio, the interpolated chrominance information and the intensive information may be combined 242 using multiplication.

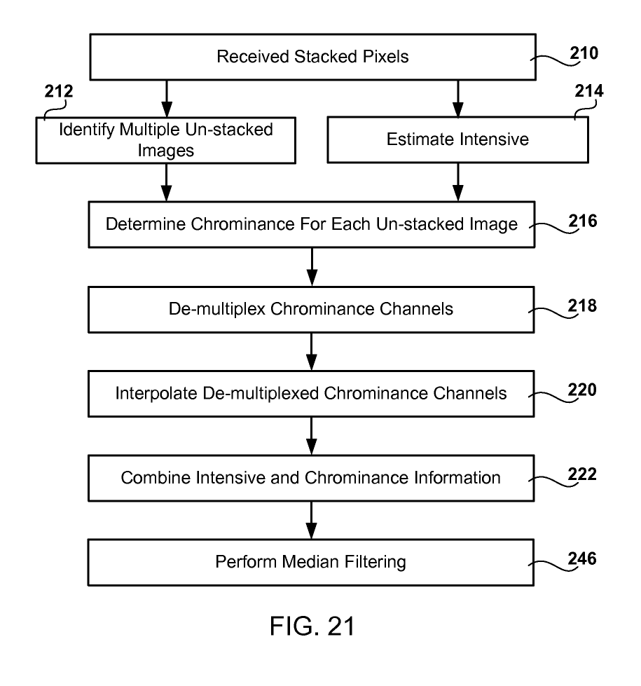

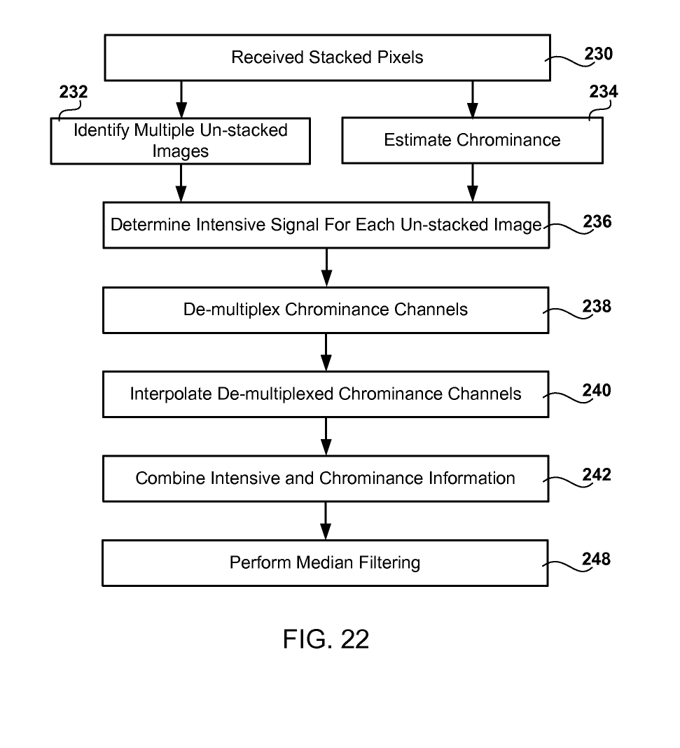

In some embodiments of the present invention described in relation to FIG. 21 and FIG. 22, median filtering 246, 248 may be performed after full-color image reconstruction.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for demosaicing an image comprising a first plurality of pixels associated with a first color component and a second color component and a second plurality of pixels associated with, at least, a third color component, said method comprising:
a) extracting a first signal of a first signal type from a first combination of color-component values associated with said first plurality of pixels and said second plurality of pixels;
b) extracting a second signal of said first signal type from a second combination of color-component values associated with said first plurality of pixels and said second plurality of pixels;
c) computing a third signal of a second signal type from said first combination of color-component values and said first signal;
d) computing a fourth signal of said second signal type from said second combination of color-component values and said second signal;
e) when said first signal type is associated with chrominance, de-multiplexing said first signal and said second signal according to said first color component, said second color component and said third color component;
f) when said second signal type is associated with chrominance, de-multiplexing said third signal and said fourth signal according to said first color component, said second color component and said third color component;
g) interpolating missing values in said first-color-component de-multiplexed signal;
h) when said first signal type is associated with intensive information, generating color data associated with said image using said interpolated first-color-component de-multiplexed signal and said first signal; and
i) when said second signal type is associated with intensive information, generating said color data associated with said image using said interpolated first-color-component de-multiplexed signal and said third signal.

2. A method as described in claim 1, wherein:
a) said first signal type is one of intensive and chrominance; and
b) said second signal type is the other of intensive and chrominance.

3. A method as described in claim 1 further comprising median filtering.

4. A method as described in claim 1, wherein said extracting a first signal comprises filtering with a first-signal-type extraction filter.

5. A method as described in claim 4, wherein said first-signal-type extraction filter comprises
a convolution kernel equivalent to
$$\frac{1}{64} [ \begin{matrix}0 & 1 & - 2 & 1 & 0 \\ 1 & - 4 & 6 & - 4 & 1 \\ - 2 & 6 & 56 & 6 & - 2 \\ 1 & - 4 & 6 & - 4 & 1 \\ 0 & 1 & - 2 & 1 & 0\end{matrix} ] .$$

6. A method as described in claim 4, wherein said first-signal-type extraction filter comprises a first filter designed by an optimization procedure, wherein said optimization is related to the separation of first information of said first signal type and second information of said second signal type.

7. A method as described in claim 1, wherein said computing a third signal of a second signal type from said first combination of color-component values and said first signal comprises subtracting said first signal from said first combination of color-component values.

8. A method as described in claim 1, wherein:
a) said second plurality of pixels is associated only with said third color component;
b) said first color component is associated with blue spectral content;
c) said second color component is associated with red spectral content; and
d) said third color component is associated with green spectral content.

9. A method as described in claim 1 further comprising:
a) interpolating missing values in said second-color-component de-multiplexed signal;
b) when said first signal type is associated with intensive information, generating said color data associated with said image using said interpolated second-color-component de-multiplexed signal and said second signal; and
c) when said second signal type is associated with intensive information, generating said color data associated with said image using said interpolated second-color-component de-multiplexed signal and said fourth signal.

10. A method as described in claim 1 further comprising:
a) calculating a fifth signal of said first signal type wherein said fifth signal is a weighted average of said first signal and said second signal;
b) calculating a sixth signal of said second signal type, wherein said sixth signal is a weighted average of said third signal and said fourth signal; and
c) wherein, when said first signal type is associated with chrominance, said de-multiplexing further comprises de-multiplexing said fifth signal; and
d) wherein, when said second signal type is associated with chrominance, said de-multiplexing further comprises de-multiplexing said sixth signal.

11. A method for demosaicing an image comprising a first plurality of pixels associated with a first color component and a second plurality of pixels associated with a second color component and a third color component, said method comprising:
a) extracting a first first-signal-type signal associated with the first-color-component values associated with said first plurality of pixels and the second-color-component values associated with said second plurality of pixels;
b) extracting a second first-signal-type signal associated with the first-color-component values associated with said first plurality of pixels and the third-color-component values associated with said second plurality of pixels;
c) computing a third first-signal-type signal associated with said first color component by combining said first first-signal-type signal and said second first-signal-type signal;
d) computing a first second-signal-type signal associated with the first-color-component values associated with said first plurality of pixels and the second-color-component values associated with said second plurality of pixels using said first first-signal-type signal and the first-color-component values associated with said first plurality of pixels and the second-color-component values associated with said second plurality of pixels;
e) computing a second second-signal-type signal associated with the first-color-component values associated with said first plurality of pixels and the third-color-component values associated with said second plurality of pixels using said second first-signal-type signal and the first-color-component values associated with said first plurality of pixels and the third-color-component values associated with said second plurality of pixels;
f) computing a third second-signal-type signal associated with said first color component by combining said first second-signal-type signal and said second second-signal-type signal;
g) when said second signal type is associated with chrominance, de-multiplexing said first second-signal-type signal, said second second-signal-type signal and said third second-signal-type signal according to said first color component, said second color component and said third color component;
h) when said first signal type is associated with chrominance, de-multiplexing said first first-signal-type signal, said second first-signal-type signal and said third first-signal-type signal according to said first color component, said second color component and said third color component;
i) interpolating missing values in said first-color-component de-multiplexed signal;
j) interpolating missing values in said second-color-component de-multiplexed signal;
k) interpolating missing values in said third-color-component de-multiplexed signal;
l) when said first signal type is associated with intensive information, forming a full-color image by combining said third first-signal-type signal, said interpolated first-color-component de-multiplexed signal, said first first-signal-type signal, said interpolated second-color-component de-multiplexed signal, said second first-signal-type signal and said interpolated third-color-component de-multiplexed signal; and
m) when said second signal type is associated with intensive information, forming said full-color image by combining said third second-signal-type signal, said interpolated first-color-component de-multiplexed signal, said first second-signal-type signal, said interpolated second-color-component de-multiplexed signal, said second second-signal-type signal and said interpolated third-color-component de-multiplexed signal.

12. A method as described in claim 11, wherein:
a) said first signal type is one of intensive and chrominance; and
b) said second signal type is the other of intensive and chrominance.

13. A method as described in claim 11, wherein:
a) said computing a third first-signal-type signal associated with said first color component by combining said first first-signal-type signal and said second first-signal-type signal comprises weighted averaging of said first first-signal-type signal and said second first-signal-type signal; and
b) said computing a third second-signal-type signal associated with said first color component by combining said first second-signal-type signal and said second second-signal-type signal comprises weighted averaging of said first second-signal-type signal and said second second-signal-type signal.

14. A method as described in claim 11 further comprising median filtering.

15. A method as described in claim 11, wherein:
a) said first color component is associated with green spectral content;
b) said second color component is associated with red spectral content; and
c) said third color component is associated with blue spectral content.

16. A method as described in claim 11, wherein:
a) said extracting a first first-signal-type signal comprises filtering the first-color-component values associated with said first plurality of pixels and the second-color-component values associated with said second plurality of pixels with a first first-signal-type extraction filter; and
b) said extracting a second first-signal-type signal comprises filtering the first-color-component values associated with said first plurality of pixels and the third-color-component values associated with said second plurality of pixels with a second first-signal-type extraction filter.

17. A method as described in claim 16, wherein said first first-signal-type extraction filter is said second first-signal-type extraction filter.

18. A method as described in claim 17, wherein said first first-signal-type extraction filter and said second first-signal-type extraction filter comprise a convolution kernel equivalent to
$$\frac{1}{64} [ \begin{matrix}0 & 1 & - 2 & 1 & 0 \\ 1 & - 4 & 6 & - 4 & 1 \\ - 2 & 6 & 56 & 6 & - 2 \\ 1 & - 4 & 6 & - 4 & 1 \\ 0 & 1 & - 2 & 1 & 0\end{matrix} ] .$$

19. A method as described in claim 16, wherein said first-signal-type extraction filter comprises a first filter designed by an optimization procedure, wherein said optimization is related to the separation of first information of said first signal type and second information of said second signal type.

20. A method for demosaicing an image comprising a first plurality of pixels associated with a first color component and a second color component and a second plurality of pixels associated with, at least, a third color component, said method comprising:
a) estimating a first first-signal-type signal of a first signal type from said first plurality of pixels and said second plurality of pixels;
b) computing a first second-signal-type signal of a second signal type from said first first-signal-type signal and a first combination of color-component values associated with said first plurality of pixels and said second plurality of pixels;
c) computing a second second-signal-type signal of said second signal type from said first first-signal-type signal and a second combination of color-component values associated with said first plurality of pixels and said second plurality of pixels;
d) when said first signal type is associated with chrominance, de-multiplexing said first first-signal-type signal and said second first-signal-type signal according to said first color component, said second color component and said third color component;
e) when said second signal type is associated with chrominance, de-multiplexing said first second-signal-type signal and said second second-signal-type signal according to said first color component, said second color component and said third color component;
f) interpolating missing values in said first-color-component de-multiplexed signal;
g) when said first signal type is associated with intensive information, generating color image data associated with said image using said interpolated first-color-component de-multiplexed signal and said first first-signal-type signal; and
h) when said second signal type is associated with intensive information, generating said color image data associated with said image using said interpolated first-color-component de-multiplexed signal and said first second-signal-type signal.

21. A method as described in claim 20, wherein:
a) said first signal type is one of intensive and chrominance; and
b) said second signal type is the other of intensive and chrominance.

22. A method as described in claim 20, wherein:
a) said second plurality of pixels is associated only with said third color component;
b) said first color component is associated with blue spectral content;
c) said second color component is associated with red spectral content; and
d) said third color component is associated with green spectral content.
